(19) United States
(12) Patent Application Publication
(10) Pub. No.: US 2026/0129264 A1
(43) Pub. Date: May 7, 2026

(54) Embedding of Notifications Within Streaming Content

(71) Applicant: Uber Technologies, Inc., San Francisco, CA (US)

(72) Inventors: Ethan Hollins, South Lake Tahoe, CA (US); Lauren Prestifilippo, San Francisco, CA (US); Christopher Marcel Stauffer, San Francisco, CA (US); Awaneesh Verma, San Francisco, CA (US)

(21) Appl. No.: 19/371,441

(22) Filed: Oct. 28, 2025

Related U.S. Application Data
(60) Provisional application No. 63/717,495, filed on Nov. 7, 2024.

(51) Int. Cl. H04N 21/478; G06F 3/0482; H04N 21/431

(52) U.S. Cl. CPC H04N 21/47815; H04N 21/4316; G06F 3/0482

(57) ABSTRACT

Systems and methods for multimodal content feature extraction for action data structure generation and execution. The system can generate a recommendation for a food item based on streaming content data or user interface data. The system can facilitate initiation of an order via an application programming interface associated with a delivery service. The system can obtain order update data. The system can process the order update data to determine a location within a streaming content user interface for an embedding window. The system can determine content to populate the embedding window. The system can generate the embedding window. The system can update the user interface to provide an order notification via the embedding window. The timing of generation of the embedding window or transmission of content for the embedding window can be based on expected network traffic bandwidth utilization.

### PRIORITY

This application claims the benefit or priority to U.S. Provisional Patent Application No. 63/717,495 , filed Nov. 7, 2024, which is hereby incorporated by reference in its entirety.

### FIELD

The present disclosure generally relates to embedding notifications within streaming content. More particularly, the present disclosure is directed to features for determining when and where to embed notifications within streaming content based on characteristics associated with the notification and content being streamed.

### BACKGROUND

Food delivery services allow a user to request a service that can be performed by a vehicle or courier. For instance, a user can request, through a food delivery service application, a food delivery service having a pick-up location, a drop-off location, and an item for delivery. A courier can be assigned to perform the food delivery service for the user. This can include transporting the delivery of the item to the drop-off location. In some cases, food delivery service applications can provide for updates relating to the delivery service status.

### SUMMARY

Aspects and advantages of embodiments of the present disclosure will be set forth in part in the following description, or can be learned from the description, or can be learned through practice of the embodiments.

One aspect of the present disclosure is directed to a computing system. The computing system includes one or more processors and one or more tangible, non-transitory, computer readable media that store instructions that are executable by the one or more processors to cause the computing system to perform operations. The operations include generating a recommendation for a comestible menu item based on at least one of: (i) streaming content data or (ii) user interface data; obtaining data indicative of user selection of the comestible menu item; accessing current streaming content data; generating a data structure comprising: (i) the selected comestible menu item and (ii) the current streaming content data; transmitting, via an application programming interface (API) associated with a delivery service, the generated data structure to a delivery service; accessing, via the API associated with the delivery service, order update data; processing the order update data and current streaming content data to determine: (i) a location within the user interface for an embedding window, and (ii) the order update content to provide within the embedding window; generating the embedding window; and updating the user interface to provide the order update content for display within the embedding window.

Another Example aspect of the present disclosure is directed to a computer-implemented method. The method includes obtaining, by a delivery service computing system, service order request data comprising: (i) an item and (ii) streaming content data; accessing data indicative of a courier location approaching a delivery location associated with the service order request; based on accessing the data indicative of the courier location approaching the delivery location, generating order update data; accessing network traffic data, based on the streaming content data and network traffic data, determining a time to transmit the order update data; and transmitting, via an application programming interface, data comprising the order update to be provided for display via a display device.

Yet another example aspect of the present disclosure is directed to one or more non-transitory computer readable media storing instructions that are executable by one or more processors to perform operations. The operations include obtaining, via a sensor of a client device, user input data indicative of initiation of a streaming session on a second device; obtaining, via the sensor of the client device, user input data indicative of selection of a comestible menu item associated with a delivery service application; obtaining, via an application programming interface in communication with a delivery service computing system, order update data; accessing streaming data associated with the streaming session on the second device; and based on the order update data and the streaming data, generating a data structure comprising instructions, that are executable to cause the second computing device to adjust streaming content associated with the streaming session based on the order update data.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example computing system for embedding notifications within streaming content according to aspects of the present disclosure.

FIG. 2 depicts a block diagram of an example computing system for embedding notifications within streaming content according to aspects of the present disclosure.

FIG. 3 depicts a flowchart of an example method according to example embodiments of the present disclosure.

FIG. 4 depicts a flowchart of an example method according to example embodiments of the present disclosure.

FIG. 5 depicts a flowchart of an example method according to example embodiments of the present disclosure.

FIG. 6 depicts a flowchart of an example method according to example embodiments of the present disclosure.

FIG. 7 depicts a flowchart of an example method according to example embodiments of the present disclosure.

FIG. 8 depicts a flowchart of an example method according to example embodiments of the present disclosure.

FIG. 9 depicts an example graphical user interface according to example embodiments of the present disclosure.

FIG. 10 depicts an example graphical user interface according to example embodiments of the present disclosure.

FIG. 11 depicts an example graphical user interface according to example embodiments of the present disclosure.

FIG. 12 depicts an example graphical user interface according to example embodiments of the present disclosure.

FIG. 13 depicts an example graphical user interface according to example embodiments of the present disclosure.

FIG. 14 depicts an example graphical user interface according to example embodiments of the present disclosure.

FIG. 15 depicts an example graphical user interface according to example embodiments of the present disclosure.

FIG. 16 depicts a block diagram of an example computing system according to example embodiments of the present disclosure.

FIG. 17 depicts a block diagram of an example computing system according to example embodiments of the present disclosure.

FIG. 18 depicts a block diagram of training one or more machine-learned models according to example embodiments of the present disclosure.

FIG. 19 depicts an example network including a network computing system and machine learning computing system according to example embodiments of the present disclosure.

### DETAILED DESCRIPTION

Generally, the present disclosure relates to providing integration between a real-time delivery service interface within a streaming platform. More particularly, the delivery service interface can be integrated such that data related to the delivery service interface appears to be native to the streaming platform. The system can determine, based on the content of the delivery service messages, how to adjust the display of content within the streaming platform. For instance, based on the content of the message, the content of the streaming platform can be paused, or somehow adjusted alongside providing the message relating to the delivery service.

More particularly, the present disclosure can provide for integration of recommendations, browsing, and order updates within the streaming platform. Recommendations can include both recommendations of streaming content to view based on comestible items being browsed or providing recommendations of comestible items to order based on streaming content being viewed. In some embodiments, multimodal content processing can be performed to extract information about items within a piece of streaming content. This information can be compared to existing comestible items. If a match or close match is determined, the system can provide a recommendation within a content viewing interface providing the ability to generate a cart or otherwise facilitate order delivery of the item based on interaction within the streaming platform.

This can be accomplished via a system which generates embedding windows within a streaming platform's content to provide for real-time order delivery updates that are natively integrated within the streaming platform. In some implementations, the embedding windows can be populated by accessing data of the real-time delivery system via API calls between the streaming platform system and the real-time delivery system. This can include determining where or when within the interface to initialize the embedding window which can be used to provide updates relating to the real-time delivery service as well as determining characteristics of the timing, content, or delivery style of the real-time delivery service communications. In some instances, characteristics of the real-time delivery service notifications can include waiting until a particular scene is over, providing an update during a commercial break, or overriding rules against providing an order update if there is an urgent notification, such as a request for selection of a replacement item, or delivery update relating to food which could get hot or cold. Additional example embodiments will be provided herein.

The present disclosure provides for a variety of technical effects and benefits. More particularly, the present disclosure provides for a new system architecture to facilitate the embedding of real-time delivery services within streaming platform content. There are numerous technical challenges with integrating real-time delivery service order placement and provision of notifications. For instance, there is a limited amount of display space. Additionally, there are challenges with determining how to set up efficient communications between the real-time delivery service and the streaming platform. As such, there is a need to provide order updates in a near real-time manner to ensure proper communication without overloading the computing resources of the streaming platform. Additionally, transmission over the network must be controlled to reduce increasing system latency. As such, determining how to efficiently select data which is transmitted over a network associated with the streaming platform as well as the real-time delivery service can be managed such that latency is reduced and a reduction of computing resource utilization is achieved.

The technology described in the present disclosure provides for more efficient usage and allocation of network traffic bandwidth. For example, streaming content services have large amounts of data to push which provides for constrained network communications to deliver content due to the vast amount of network traffic. The technology of the present disclosure can avoid adding to this problem by avoiding pushing continuous or constant notifications. By taking into account characteristics of the content being streamed when deciding when and where to send additional content such as delivery notifications, the technology of the present disclosure provides for improved network traffic bandwidth allocation.

Streaming systems generally preload a portion of streaming content to avoid buffering if network bandwidth is reduced during playback of content. The technology of the present disclosure can provide for temporarily stopping streaming communication of video data such that the network bandwidth can be utilized for transmitting delivery notifications. Since there is a portion of the streaming content which is preloaded or locally cached, the streaming content can continue to play the locally cached content while the delivery notifications are being transmitted. This smart selection of network bandwidth utilization can provide for the same or less bandwidth usage while preventing any buffering or suspension of playing streaming content while the delivery notification data is being transmitted between a delivery service system and a display device. Upon completion of transmitting the delivery notification data, the system can resume transmission of the streaming content which can be locally cached on the display device.

In some instances, the system can pause the display of streaming content to display the order updates within the streaming content. In some instances, the streaming content display can be resumed based on receipt of user input and the delivery status. For instance, the download of the streaming content to a local cache can continue when the streaming content is automatically paused by the status indicated that states that food has arrived and the delivery service has been complete. This is beneficial because upon completion of the delivery service, a user will need to grab the food, unpack the food, or prepare the food, and want to pause the streaming content when away from the screen.

Additionally, the technology described herein can intelligently determine when to transmit data relating to order notifications based on current network traffic levels as well as predicted network traffic levels. For instance, if network traffic for a particular geographic area is high in the aggregate, but the system has a predictor indicating that network traffic is expected to be less in ten seconds, the system can delay the transmission of the delivery service notification data for ten seconds. The technology of the present disclosure can take many factors into account when determining when and where to provide order notifications. Some factors can include network bandwidth as previously discussed as well as types of items associated with the order. For instance, a notification can be held for items that are non-perishable such as canned soup, a bag of popcorn, or a candy bar, but are not held for items that are hot or cold such as a pasta dish, soup, or ice cream.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. With reference to the figures, example embodiments of the present disclosure will be discussed in further detail.

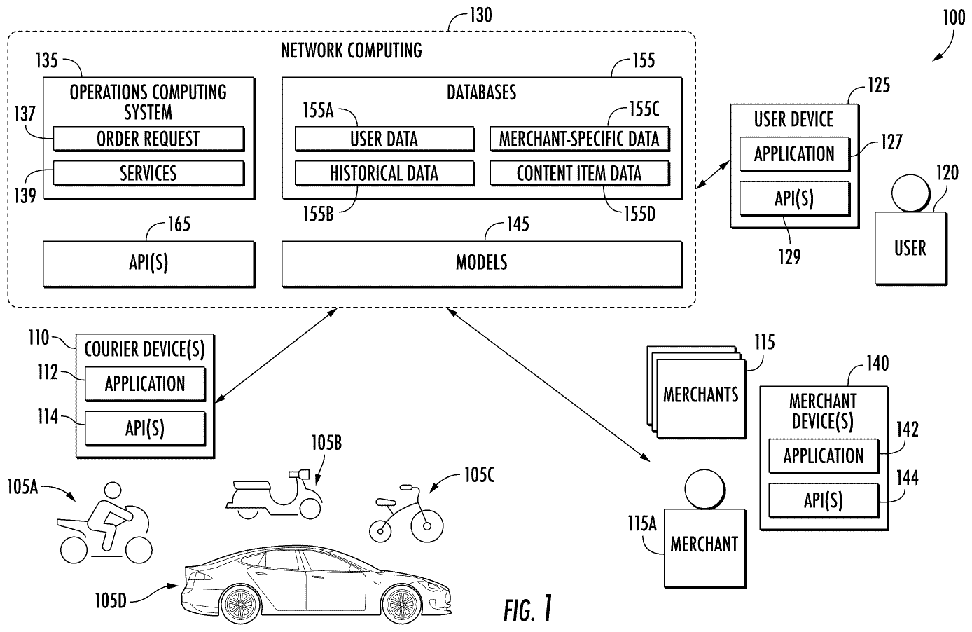

FIG. 1 depicts a block diagram of an example computing system 100 for embedding of notifications within streaming content according to aspects of the present disclosure. As illustrated, FIG. 1 shows a computing system 100 that can include one or more vehicles 105A-D (e.g., a car, scooter, motorcycle, bicycle) and one or more courier devices 110 that can be associated with one or more couriers. In some examples, the one or more couriers are humans. In some examples, the courier can be non-human (e.g., vehicle, autonomous vehicle, autonomous robot). The one or more couriers and the one or more courier devices 110 (e.g., an onboard tablet, a mobile device of a courier) can be associated with the one or more vehicles 105A-D. The courier device(s) 110 can include a software application 112 associated with the food delivery service entity, which can run on the courier device(s) 110. The courier device(s) 110 can include one or more application programming interfaces (API(s) 114) for facilitating communication between the courier device(s) 110 and the network system 130.

The computing system 100 can include one or more merchants 115. The merchants 115 can receive data indicative of a food delivery service request from a user 120. A food delivery service request can include a request for premade items from a restaurant or delivery of ingredients from a grocery store. For example, the user 120 can submit a request through a user device 125 associated with the user (e.g., via a software application 127 or API(s) 129). A user device can include a mobile device like a cell phone, a computer, a smart television, or any other device capable of connecting to the network system 130. In some instances, user device 125 can include a number of user devices associated with user 120. A network system 130 can include an operations computing system 135 associated with a service entity that can facilitate a request for services from user 120.

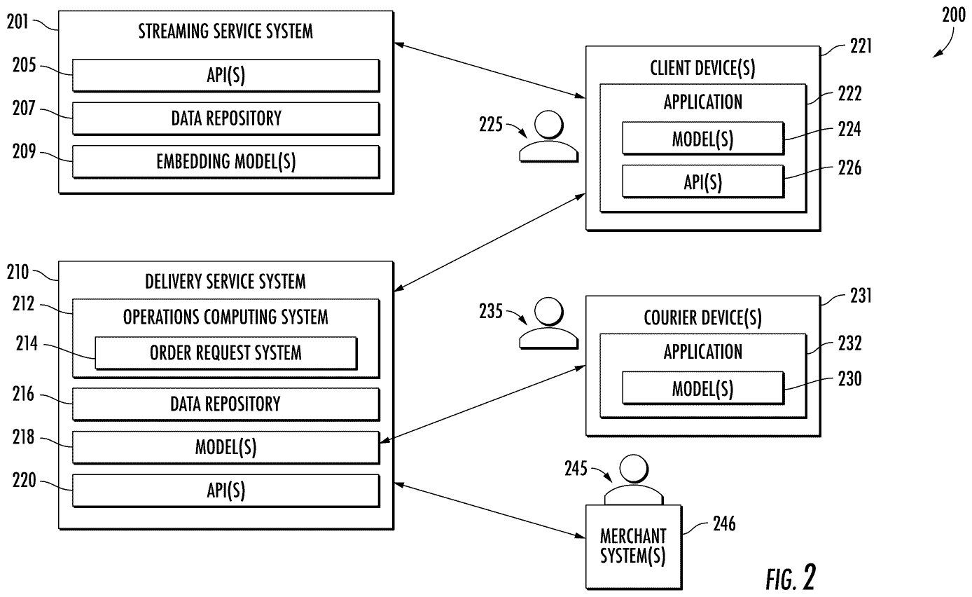

An operations computing system 135 associated with the food delivery service entity can facilitate a request for services from user 120. For example, the user 120 can submit a food delivery request through a user device 125 associated with the user 120 (e.g., via a software application 127). In some instances, software application 127 can be associated with the food delivery service. Additionally, or alternatively, software application 127 can be associated with a content streaming service. This integration with the content streaming service will be discussed further with regard to FIG. 2. Operations computing system 135 can receive a food delivery service request for an order request 137 from a user device 125.

The operations computing system 135 can send data indicative of order request 137 to a merchant device 140 associated with a merchant 115A (e.g., via a software application 142 or API(s) 144).

In some implementations, merchant devices 140 can aggregate service requests from a number of systems. For instance, the number of systems can be associated with a number of different entities. By way of example, network system 130 can be one system of the number of systems. The API(s) 144 can be structured such that the merchant devices can receive data associated with order request 137 from the network system 130 and aggregate the data associated with order request 137 with additional order request data from other sources. In some instances, the other sources can include additional service entities. As such, the merchant devices 140 can facilitate completion of service requests received from systems and applications in addition to a software application directly associated with network system 130. This can be accomplished, for example, via an aggregator software application that is programmed to access the service requests via a number of APIs and display them on the merchant device 140 through a user interface.

The operations computing system 135 can receive data indicative of a merchant 115A accepting a food preparation request. Data indicative of the merchant 115A can include, for example, food being prepared, estimated preparation time, or estimated shopping time for grocery items. The operations computing system 135 can send a request to a courier device 110 associated with the courier to complete the order request 137 (e.g., via application 112 or API(s) 114).

The network system 130 can include models 145. Models 145 can include an embedding window generation model, a notification timing model, or a dish recommendation model. In some instances, models 145 can include a single model. In some instances, models 145 can include multiple models. An embedding window generation model can determine a location within streaming content for an embedding window for displaying notifications associated with the food delivery request. A notification timing model can determine when to transmit notifications to user device 125 based on information associated with the streaming content, the food delivery request, and network traffic utilization. Dish recommendation model can determine recommendations for items for delivery via the food delivery service based on the streaming content being displayed or browsed on user device 125.

The network system 130 can include a data repository 155. The data repository 155 can include user data 155A, historical data 155B, merchant-specific data 155C, content item data 155D, or any other relevant data. User data 155A can include data associated with user 120. Historical data 155B can include data associated with user 120, data associated with merchant(s) 115, data associated with couriers. Merchant-specific data 155C can include real-time data associated with merchants 115. Content item data 155D can include data associated with one or more streaming content items. Other relevant data can include system-level data associated with a number of users, expected demand, current or expected utilization of network bandwidth.

User data 155A can include data associated with a user. User data 155A can include user preference data or other data that can be utilized by the operations computing system 135 to generate recommendations of content items or food items.

Historical data 155B can include data associated with a user, data associated with one or more merchants, data associated with one or more couriers, or data associated with content item interactions. Historical data can include information associated with users, merchants, couriers, or content items. For example, historical data can include a previous delivery service order request that indicates items, merchant locations, and feedback from a user. In some examples, historical data can include the history of specific grocery items, specific prepared items, or specific content items.

Merchant-specific data 155C can include real-time data associated with merchants. For instance, merchant-specific data 155C can include hours associated with a location, inventory, menu items, number of current order requests being processed, or any other relevant merchant data.

Content item data 155D can include data associated with one or more streaming content items. In some instances, content item data 155D can include metadata associated with one or more content items. For instance, metadata can include categorization data, extracted feature data, creator information, time data, performance data, frame data, scene data, or other data. In some implementations, content item data 155D can include data associated with food items that have been ordered by viewers of the streaming content. For instance, when watching a movie about traveling to Italy, viewers can regularly order pasta or Italian for delivery.

The technology described herein includes the collection of data and provision of certain content to users associated with a delivery service. Users can be given the opportunity to customize data collection and provision features. Data collection and provision can be configured with options for permissions to be obtained from users such that data is collected or provided for authorized use in accordance with the disclosed techniques. For example, a user can control whether certain usage data is collected and/or whether certain content is provided to the user (e.g., through opt-out features, settings). Any personal data can be removed, and data can be stored in a secured, anonymized manner. In this manner, the users can be provided control over what data is collected, used, and provided to a user for the implementations described herein.

The models 145 can use data from the data repository 155 to extract feature data from content item data 155D. The extracted feature data can be utilized to surface one or more recommended items, ingredients, or merchants which can be surfaced for display on a user device 125 (e.g., via application 127). Additionally, or alternatively, the extracted feature data can be utilized to determine when to transmit notifications associated with the food delivery request such that the notifications can be surfaced within an embedding window of streaming content being displayed on user device 125.

The operations computing system 135 can generate data indicative of the order request 137 or an action data structure associated with an order request. Data indicative of the order request 137 can include, for example, estimated time of departure, estimated time of arrival, estimated preparation time, real-time updates on order preparation, real-time updates on order location. An action data structure associated with an order request can, for example, be executed by the network system 130 to initiate and facilitate completion of order request 137. The operations computing system 135 can provide data for display on a user device 125 (e.g., via application 127) indicative of updates on the order request 137. For example, an update can include an update about what stage of delivery the order is in. Stage of delivery can include, for example, preparation, pick-up by courier, courier in route, approaching delivery, or delivered. In some instances, network system 130 can determine a timing of providing the updates on the order request 137 based on streaming content being displayed via user device 125, contents of the food delivery order, or network bandwidth utilization.

An operations computing system 135 associated with the service entity can receive an order request 137 from the user device 125. The operations computing system 135 can send a request to a courier device 110 associated with a courier (e.g., via a software application 112 or API(s) 114) for the courier to perform the requested order request service. The courier can be associated with the vehicle (e.g., vehicle 105A-D).

The operations computing system can communicate data indicative of the food delivery service assignment to a courier. A courier can include, for example, a human courier, an autonomous vehicle courier, or an autonomous robot courier. For instance, the operations computing system 135 can send a request to the courier device 110 of the courier. The request can be communicated to the courier via the software application 112 running on the courier device 110 associated with the courier. The request can include, for example, a request for the courier to accept the food delivery service assignment. Additionally, or alternatively, the operations computing system 135 can send a request to a courier device(s) 110 (e.g., a tablet stored onboard the vehicle) of at least one of vehicles 105A-D. The request can be communicated to the courier via the software application 112 running on a courier device 110. The courier can provide user input to the courier device 110 (e.g., via the software application 112) to accept or decline the vehicle service assignment. In some examples, user input can be provided directly into a service application. Additionally, or alternatively, user input can be provided via an application programing interface (API) (e.g., API(s) 114) and/or a third party application. Data indicative of the acceptance or rejection of the request can be provided to the operations computing system 135.

The computing systems of FIG. 1 can be utilized to facilitate food delivery service order requests, providing notifications of food delivery service updates, action data structure generation, or action data structure execution. For example, the network system 130 can include various sub components such as services 139 or API(s) 165.

Services 139 can include backend computing services that are programmed to perform certain computing functions. The services 139 can be accessed via an API gateway that can route messages to the specific services based on the data encoded in the messages. The messages can be formatted based on one or more APIs, which can include instructions for a computing device (or software application) to request/report certain information.

The services 139 can include prepare dish service, grocery service, or content management service. Prepare dish service can receive an order request for a prepared comestible item. The order request can include a request for one or more prepared menu items or can include one or more individual ingredients. In some instances, order request can include non-comestible item such as utensils needed for preparing specific dishes. The order request can be processed via an API gateway such that the information is encoded in messages which can be formatted such that receiving computing devices (or software applications) are able to decode and utilize such information. For instance, the information can include executable instructions which automatically trigger the initiation of actions or processing to be performed by the receiving computing device.

Operations computing system 135 can generate data indicative of the order request or an action data structure associated with an order request. The data indicative of the order request can include estimated time of departure, estimated time of arrival, estimated preparation time, real-time updates on order preparation, real-time updates on order location. The action data structure associated with the order request can be executed by network system to initiate and facilitate completion of order request. The operations computing system can provide data for display on a user device indicative of updates on the order request. For example, an update can include an update about what stage of delivery the order request is in. The stage of delivery can include, for example, preparation, pick-up by courier, courier in route, approaching delivery, or delivered.

The operations computing system 135 can communicate data indicative of the order request via one or more services 139. Prepare dish service can communicate data indicative of one or more items to be prepared by one or more merchants. The data indicative of the one or more items to be prepared can be received by one or more merchant device(s) via an application or API(s) on the device.

The operations computing system 135 can communicate data indicative of the order request via grocery service. Grocery service can communicate data indicative of one or more items to be shopped by a shopper at one or more merchants. For instance, the one or more merchants can include a grocery store or other store where individual ingredients can be purchased. The data indicative of the one or more items to be prepared can be received by one or more merchant device(s) via an application or API(s) on the device. In some implementations, grocery service can communicate data indicative of one or more items to be shopped by a courier at one or more merchants. For instance, a courier can perform a shopping portion of an order and a delivery portion of an order.

Operations computing system 135 can include a content management service. Content management service can help facilitate updates regarding the order being provided for display within streaming content. Content management service can receive a request for an order update to be transmitted to a user device. In some instances, content management service can obtain context data associated with a current service application session on a user device. The content management service can determine a timing or placement of a notification within streaming content. In some instances, content management service can transmit an action data structure that upon execution by application 127 on user device 125 causes an alteration of the streaming state of the streaming content. For instance, an alteration of the streaming state can include pausing the content, playing the content, generating an embedding window, or some other streaming state change associated with the streaming content.

Network system 130 can utilize one or more API(s) 165 to facilitate execution of action data structures for facilitating the delivery of notifications associated with order requests by one or more of services 139. Network system 130 can utilize one or more API(s) 165 to facilitate communication between network system 130 and user devices to provide notifications associated with order request 137.

FIG. 2 depicts a block diagram of an example system 200 to perform embedding of notifications into streaming content in accordance with some embodiments of the present disclosure. The example system 200 can include a streaming service system 201, delivery service system 210, one or more users 225 associated with one or more client devices 221, one or more couriers 235 associated with one or more courier devices 231, and one or more merchants 245 associated with one or more merchant systems 246. In some examples the one or more merchants 245 can be associated with the courier devices 231 (e.g., an operator a vehicle for transporting items from a merchant to a drop off location, an individual to pickup an item from a restaurant, a designated shopper at a merchant location). The example system 200 can facilitate the embedding of delivery service notification within streaming content.

Additionally, example system 200 can facilitate the provision of streaming and delivery services between the users 225 and the merchants 245 by utilizing couriers 235 to retrieve requested items from merchant locations associated with the merchants 245. This can include, for example, a restaurant or grocery delivery service that includes the retrieval of one or more prepared items or grocery items.

With respect to examples as described herein, the system 200 can be implemented on a server, on a combination of servers, or on a distributed set of computing devices which communicate over a network such as the Internet. For example, the system 200 can be distributed using one or more servers or mobile devices. In other examples, the system 200 can be implemented as part of, or in connection with a delivery service system, where, for example, operators (e.g., couriers 235, couriers, etc.) use service vehicles to provide delivery services for requesting users 225. In some examples, the system 200 can be implemented using mobile devices of users (e.g., client devices 221, courier devices 231) associated with users 225, couriers 235 and merchants 245 with the individual devices executing a corresponding service application (e.g., application 222, application 232) that causes the computing device to operate as an information inlet or outlet for the streaming service system 201. In other examples, the system 200 can be implemented using one or more merchant systems 246 associated with one or more merchants 245. The merchant system 246 can operate as an information inlet and/or outlet for the system 200 to exchange data with the delivery service system 210.

Streaming service system 201 can communicate with client device(s) 221 via application 222 to provide streaming content items. Model(s) 224 can include an embedding window model. The embedding window model can determine when and where to generate an embedding window within a streaming content item. In some instances, embedding window model can determine a size and duration for an embedding window within the streaming content item. Application 222 can communicate with streaming service system 201 or delivery service system 210 to obtain streaming content items or updates relating to an order request of the delivery service system. For instance, API(s) 226 can communicate with API(s) 205 to obtain data associated with one or more streaming content items. API(s) 226 can communicate with API(s) 220 to obtain order update data relating to an order request. In some instances, a user can initiate an order request via application 222. In some instances, the order request can be placed via an application associated with a streaming service system 201. In some instances, the order request can be placed via an application associated with the delivery service system 210.

The delivery service system 210 can communicate with streaming service system 201 and client device(s) 221 to determine when and how to provide embedded notifications relating to a delivery order within streaming content. For instance, streaming service system 201 can include one or more API(s) 205 to interface with client device(s) 221 or delivery service system 210. Streaming service system 201 can include a data repository 207 including a number of streaming content items. In some instances, streaming content items can include media such as television shows, movies, short films, social media content, or live broadcasting content. Streaming service system 201 can include one or more embedding model(s) 209 which can be used to facilitate generation of embedding windows or other interaction between notifications associated with delivery service system 210 and the streaming content items being displayed via the client device(s) 221. The generation of the embedding windows will be described in greater detail herein.

The delivery service system 210 can include a number of systems and components for performing various operations. For example, the delivery service system 210 can include an operations computing system 212, data repository 216, one or more machine-learned models 218, and one or more API(s) 220. The delivery service system 210 can be any computing device that is capable of exchanging data and sharing resources. For example, the delivery service system 210 can include one or more networked devices configured to store or transmit data over physical or wireless technologies. In some examples, the delivery service system 210 can include hardware and software. In other examples, the delivery service system 210 can include physical equipment that is connected to a physical network.

The delivery service system 210 can include an operations computing system 212. In some examples, the operations computing system 212 can be implemented by one or more computing devices. For example, the operations computing system 212 can include one or more processors and one or more memory devices. The one or more memory devices can store instructions executable by the one or more processors to cause the one or more processors to perform operations or functions associated with other systems or components of the delivery service system 210.

In some examples, the operations computing system 212 can include an order request system 214 configured to receive order requests from users 225 for food delivery services. For example, a user 225 can submit a grocery/food delivery service order request through an application 222 running on the client device 221 associated with the user 225. In some examples, the order request can be submitted via an application associated with the streaming service system 201 or an application associated with delivery service system 210. In some instances, these can be separate applications. In some instances, these can be a single application.

In some examples, the order request system 214 can receive a single delivery service order request from a user 225. In some examples, the order request system 214, can receive multiple delivery service order requests from multiple users 225. In some examples, the order request system 214 can coordinate multiple delivery service order requests from the same user 225 which require selection or delivery of items from multiple merchant locations.

The order request system 214 can perform actions to coordinate a completion time of an order request including an estimated time of arrival for requested items. In some instances, the streaming service system 201 or delivery service system 210 can determine a network bandwidth utilization of the client device(s) 221. The network bandwidth utilization of individual client devices or the aggregate of all of the client devices can be utilized by the example system 200 in determining when to transmit data including the delivery order update data. For instance, streaming systems generally preload a portion of streaming content to avoid buffering if network bandwidth is reduced during playback of content. In instances where the system determines an increase in network traffic, the technology of the present disclosure can provide for temporarily stopping streaming communication of video data such that the network bandwidth can be utilized for transmitting delivery notifications. Since there is a portion of the streaming content which is preloaded or locally cached, the streaming content can continue to play the locally cached content while the delivery notifications are being transmitted. This smart selection of network bandwidth utilization can provide for the same or less bandwidth usage while preventing any buffering or suspension of playing streaming content while the delivery notification data is being transmitted between a delivery service system and a display device. Upon completion of transmitting the delivery notification data, the system can resume transmission of the streaming content which can be locally cached on the display device.

In some examples, the order request system 214 can provide data indicative of the delivery service request to other systems and components of the delivery service system 210 for further processing or storage. For instance, the order request system 214 can provide data indicative of the delivery service request to the data repository 216. The data repository 216 can include, for example, data stores such as relational databases, non-relational databases, key-value stores, full-text search engines, message queues, etc.

The data repository 216 can include user data, historical data, and merchant data. Such data can be encrypted, stored in a secure manner, pseudonymized, or optionally collected (e.g., as selected by the user 225). In some examples, the data repository 216 can be replicated to ensure the data stored in the data repository 216 is readily available for the number of client devices 221, courier devices 231, or the merchant systems 246.

User data can include data associated with the users 225 of the delivery service entity. In some examples, the user data can include user profile information (e.g., name, address, payment information) and user preferences (e.g., essential items, replacement items, etc.) of the users 225. In other examples, user data can include geographical information regarding the current location of the client device 221 associated with the user 225. For example, a user 225 can be on vacation and can be located in a different geographical location than the address associated with the user 225. For instance, the user 225 can consent to providing user data including the current geographical location of the client device 221 associated with the user 225.

Historical data can include historical information associated with the users 225. For example, historical data can include a previous delivery service order requests (e.g., order history) that indicate items, merchant locations, and feedback from a user 225. In some examples historical data can be specific to a user 225 (e.g., order history of a specific user 225 or content streaming viewing history). In other examples, historical data can be an aggregate of historical information for a number of users 225 in a geographic region.

Historical data can be any relevant historical information associated with the usage of the delivery service entity by the user 225.

Historical data can include historical information associated with merchants 245. For example, historical data can include the history of the availability of specific items at a merchant location, historical inventory trends, completion time to prepare an order, frequently ordered items, etc. In some examples, historical data can be specific to a merchant 245 (e.g., restaurant, franchise chain, grocery store chain) or merchant locations associated with the merchant 245 (e.g., a specific merchant location of a number of merchant locations). In some examples, historical data can include preparation time for particular menu items associated with a restaurant. Historical data can include historical trends associated with increase in orders or decrease in orders based on the time of day, the day of the week, etc. Historical data can include popular food items associated with particular streaming content items. For instance, individuals watching sports can be more likely to order a pizza, wings, or other traditional sports watching food. Alternatively, a movie that is romantic can be associated with historical orders of food from a higher priced restaurant.

In some examples, the data repository 216 can be updated by the client devices 221, the courier devices 231, and the merchant systems 246. For example, as the user 225 submits, via the application 222 running on the client device 221, a delivery service order request, the data repository 216 can be updated to reflect the delivery service order request. In some examples, the courier devices 231 can update, via the application 232 running on the courier devices 231, the data repository 216 by providing updates (e.g., item unavailable, shopping complete, etc.) associated with the delivery service order request. In other examples, the merchant systems 246 can update the data repository 216 to reflect changes such as inventory levels at merchant locations, operating hours of the merchant locations, etc. The data repository 216 can be updated dynamically (e.g., as events occur) or can be updated on a scheduled reoccurring basis.

In some examples, one or more machine-learned models 218 can utilize the data stored in the data repository 216. By way of example, the one or more embedding model(s) 209 can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

As indicated, the system 200 can include various users 225 and client devices 221. The users 225 can include individuals, or a group of individuals associated with a user profile configured to interact with the delivery service entity. In some examples, the users 225 can utilize a guest profile (e.g., one time use) to interact with the delivery service entity. The client device 221 can include a connected device such as a television, smart television, or other computing device for displaying streaming content. The client device 221 can include a mobile computing device, such as a smartphone, tablet computer, laptop computer, VR or AR headset device, and the like. As such, the client device 221 can include components such as a microphone, a camera, a satellite receiver, and a communication interface to communicate with external entities using any number of wireless communication protocols. In some examples, the client device 221 can store a designated service application (e.g., application 222) in a local memory. In some examples, the memory can store additional applications executable by one or more processors of the client device 221, enabling access and interaction with one or more host servers over one or more networks. In some examples, client devices 221 can communicate with the delivery service system 210 over one or more networks.

The client device 221 can be associated with the user 225 and allow the user 225 to interact with the streaming service system 201 and delivery service system 210. For example, in response to user input by the user 225, the application 222 can interact with the client device 221 to display an application interface on a user interface of the client device 221. In some examples, the user 225 can select items (e.g., via a touch or cursor user input) and submit a delivery service order request through the application 222 running on client device 221. In some examples, the user 225 can view order updates (e.g., order in progress, complete, unavailable items, etc.) on the user interface of the user device. In some examples, the user 225 can view an ETA (estimated time of arrival) for the order request.

In some examples, the client device 221 can receive data from the delivery service system 210. For example, the application 222 can receive data stored in the data repository 216 of the delivery service system 210. In some examples, the application 222 can interact with the client device 221 to display the historical data associated with the user 225 (e.g., a user's order history). In some examples, the application 222 can interact with the client device 221 to display merchant data (e.g., available items at a merchant location). In other examples, the application 222 can interact with the client device 221 to display user data including user preference selections, related items, and suggestions for items that are likely to be desired by the user 225.

In some examples, items can be indicated as time sensitive based on the type of item. For instance, temperature considerations can cause an item to be designated as a time sensitive item. By way of example a user 225 can request ice cream. Due to ice cream needing to maintain a cool temperature, the ice cream item can be designated as time sensitive item which can need to have notification without delay. In another example, a user 225 can request a rotisserie chicken item. Due to the rotisserie chicken item needing to maintain a hot or warm temperature, the item can be designated as a time sensitive item and notifications associated with the item can be provided without delay. Alternatively, a user 225 can request a shelf-stable item such as a candy bar or pack of soda. Due to the candy bar or pack of soda being shelf stable, a notification associated with an order update for the items can be delayed or re-timed to account for characteristics associated with a streaming content item.

In some examples, the client device 221 can receive data from the delivery service system 210 including related items and suggestions for items. Related items can include items that are generally related to items included in the order request or items associated with the subject matter of streaming content items. For instance, a related item to wings can be a side of celery or pizza. In some implementations, related items can be located from a single merchant such as a single restaurant. Additionally, or alternatively, related items can be located from separate merchants. By way of example, a related item for dinner items can include recommended desserts. As an additional example, a related item for a steak item added to the order request can be potatoes.

Suggestions for items can include suggestions based on previous order requests. For instance, suggestions for items can include one or more items that have previously been included in an order request with an item included in the current order request. In some examples, suggestions for items can include one or more items from previous order requests for the requesting user 225. In other examples, suggestions for items and can include one or more items from previous order requests from an aggregate of users 225. In some implementations, this type of information can be included in user data.

In some implementations, suggestions for items can include suggestions based on items determined to be within streaming content items. For instance, a streaming content can include a food item such as a pizza, Italian food, or fast food from a particular brand of restaurant. The present disclosure can provide for determining the food item depicted in the content and suggesting the same or a related food item based on the match or similarity.

Turning to the examples, if pizza is depicted in the streaming content item, pizza can be recommended. If Italian food is depicted in the streaming content item, Italian food can be recommended. If fast food from a particular brand of restaurant is depicted in the content, then fast food from a particular brand of restaurant, and even specific items from that brand of restaurant, can be recommended to the user for purchase via the delivery service application. In some cases, the food items can be depicted in streaming content such as a movie, television show, or live programming. Additionally, or alternatively, the food items can be depicted in an advertisement being displayed within the streaming content.

The system 200 can include couriers 235 and courier devices 231. Couriers 235 can be used to retrieve requested restaurant items from a restaurant location or to retrieve requested grocery items from a merchant location. In some examples, the couriers 235 can include the individual transporting requested items, or an individual associated with the merchant 245 (e.g., a designated shopper at a merchant location). The courier devices 231 can include a mobile computing device, such as a smartphone, tablet computer, laptop computer, VR or AR headset device, and the like. As such, the courier devices 231 can include features such as a microphone, a camera, a satellite receiver, and a communication interface to communicate with external entities using any number of wireless communication protocols.

In some implementations, the courier devices 231 can be a courier device via which a courier receives data associated with the delivery service order request. This can include instructions for traveling to a merchant location associated with one or more merchants 245, items selected by a user 225, etc.

In some implementations, the courier devices 231 can be a mobile computing device associated with a merchant location. This can include a dedicated tablet, phone, etc. that is utilized by a couriers 235 within the merchant location. The courier devices 231 can receive, for a merchant 245, data that is associated with the delivery service order request. This can include items selected by a user 225, pick-up times, etc. In some implementations, a courier devices 231 can be communicatively connected to a computing system of the merchant location (e.g., inventory systems, POS systems, etc.).

In some examples, the courier devices 231 can store a designated service application (e.g., application 232) in a local memory. In some examples, the memory can store additional applications executable by one or more processors of the courier devices 231, enabling access and interaction with one or more host servers over one or more networks. In some examples, courier devices 231 can communicate with the delivery service system 210 over one or more networks.

The system 200 can include merchants 245 and merchant systems 246 that operate as an information inlet and/or outlet for the system 200 to exchange data with the delivery service system 210. Merchants 245 can include any person or company involved in the trade or sale of items (e.g., grocery items, restaurant items). Merchants 245 can be associated with merchant locations (e.g., physical locations, stores, etc.) where items can be purchased. Example merchant locations include restaurants, food courts, conventional supermarkets, limited assortment supermarkets, supercenters, warehouse clubs, or convenient stores. In some examples, merchants 245 can be associated with courier devices 231. For example, merchants 245 can offer shopper services (e.g., a designated shopper at a merchant location) to select items requested using the delivery service entity. In some examples, merchants 245 associated with a courier devices 231 can perform similar operations as a couriers 235 as described herein.

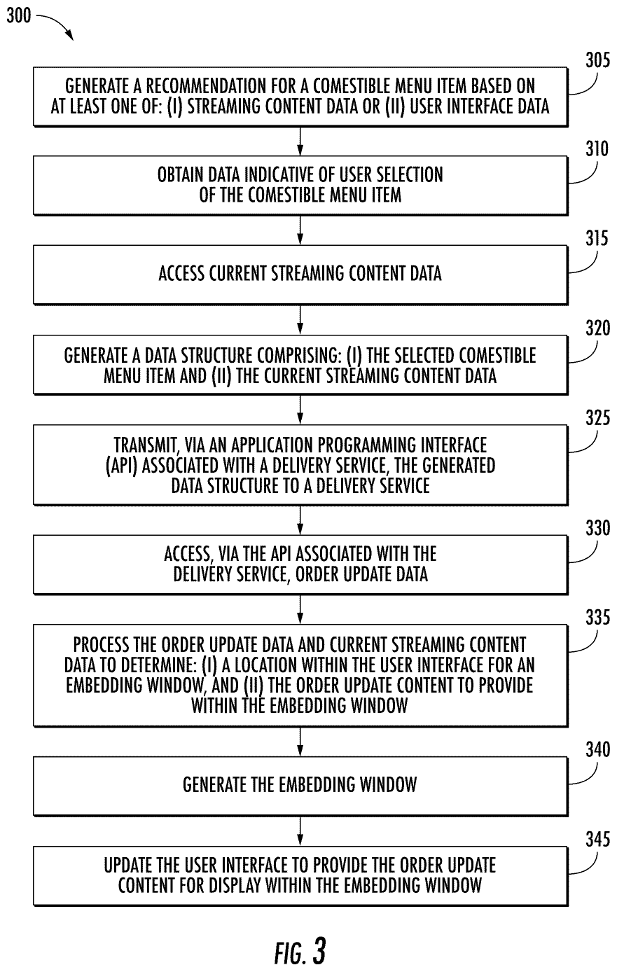

FIG. 3 depicts a flowchart diagram of an example method 300 to perform embedding of notifications into streaming content in accordance with some embodiments of the present disclosure. Method 300 can be performed by processing logic that can include hardware (e.g., computing devices, processing devices, circuitry, programmable logic, dedicated logic, hardware of a device, microcode, integrated circuit, etc.), software (e.g., instructions that are executable or can run on a processing device), or a combination thereof. In some implementations, method 300 can be performed by a network computing system (e.g., network system 130) which can be a distributed computing system (e.g., cloud-based systems). FIG. 3 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure, and some processes can be performed in parallel. In some embodiments, one or more processes can be omitted. Thus, not all processes are required by every embodiment. Additional or alternative process flows are possible.

At operation 305, processing logic can generate a recommendation for a comestible menu item based on at least one of: (i) streaming content data or (ii) user interface data.

The streaming content data can include metadata including at least one of: (i) a title, (ii) frame data, (iii) category data, or (iv) a type of content. The type of content can include at least one of: (i) a movie, (ii) an episode, or (iii) a live program. A title can include a name or other identifier of the streaming content item. Frame data can be data associated with individual frames of the content. This can include text associated with the script in that scene, any sort of tags associated with particular scenes, or any other data relevant to particular frames of the streaming content. A type of content can include an indication of the type or genre of content. Such as a movie, television show, live broadcast, sports, news, comedy, lifestyle, reality television, or any other genre or content type.

The user interface data can include at least one of content selection data or content search data. Content selection data can include data associated with a currently selected content item or a historically selected content item. As such, the content selection data can be gleaned for insights on patterns in content selection and implications of selection of certain kinds of content or patterns in the timing of selection of certain kinds of content. For instance, if a baking show is regularly watched at night time, it can be inferred that if a user is logging into a streaming session at night, they will select the baking show. Additionally, this can further be utilized to recommend items based on the subject matter of the selected content. Content search data can include search terms, search results, search results that have been viewed, search results that have been ignored, or other data related to searching. The search query itself can provide insights for type of content being searched for. Search results which are seen and either selected or ignored can also provide insights into what the user is interested in and what food items may pair well with the current streaming session intent of the user.

At operation 310, processing logic can obtain data indicative of user selection of the comestible menu item. For instance, a user can make a selection via a user interface of a first food item associated with a restaurant. The selected food item and associated data can be transmitted to a food delivery service provider for facilitating a delivery request.

At operation 315, processing logic can access current streaming content data. Current streaming content data can include data associated with a content item that is being streamed. For instance, a user can be viewing a video or television show about chefs in a city.

At operation 320, processing logic can generate a data structure including: (i) the selected comestible menu item and (ii) the current streaming content data. As such, the system can generate a data structure that includes an indication of a food item that has been selected by the user as well as data which gives additional context related to the content item currently being streamed. For instance, the selected comestible menu item can be one of a number of items in a cart. The current streaming content data include type and length of content among other content characteristics can provide the system with context for the viewing session.

At operation 325, processing logic can transmit, via an application programming interface (API) associated with a delivery service, the generated data structure to a delivery service. As such, the delivery service can obtain data associated with the delivery service request to initiate communication with merchants to begin preparing items for the delivery service as well as communication with couriers to facilitate the delivery of the items associated with the order. The streaming content data can be utilized by the system in determining when and how to provide order update data via an embedding window associated with the streaming content item.

At operation 330, processing logic can access, via the API associated with the delivery service, order update data. For instance, the delivery service can be tracking a courier and determine that the courier has picked up the food items for the delivery order from the merchant and will arrive at the drop-off location in an estimated amount of time.

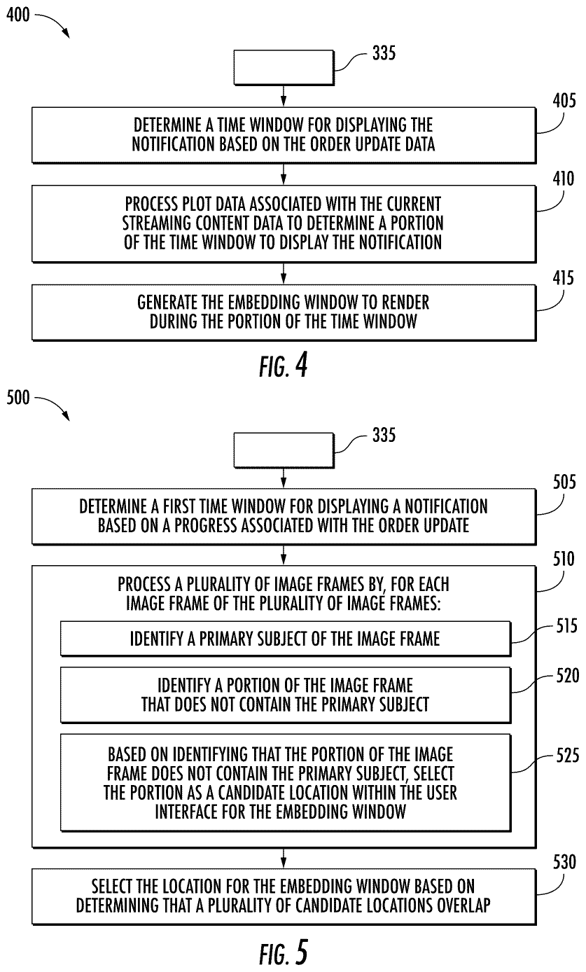

At operation 335, processing logic can process the order update data and current streaming content data to determine: (i) a location within the user interface for an embedding window and (ii) the order update content to provide within the embedding window. As such, processing logic can determine where within the graphical user interface of a display device to embed the order update in such a way that it will not be disruptive to the end-user content streaming experience. For instance, the embedding window can be generated such that prominent portions of the content are not obstructed. The order update content can include different kinds of notifications based on the stage of progress of the order delivery. The timing and placement of the embedding window will be discussed further with regard to the operations discussed in FIG. 4 and FIG. 5.

In some instances, method 300 includes method 400 and method 500 depicted in FIG. 4 and FIG. 5.

At operation 405, processing logic can determine a time window for displaying the notification based on the order update data. For instance, an order notification associated with a courier having picked up an item and departed a restaurant can be associated with an ideal notification time window of two minutes from pick-up. As an alternative, an order notification associated with a courier arrive and delivering a content item can be a time window of thirty seconds.

At operation 410, processing logic can process plot data associated with the current streaming content data to determine a portion of the time window to display the notification. For instance, utilizing the metadata associated with the content item, the system can determine whether there is currently a lull in the plot of the streaming content, whether a new exciting moment is expected to occur in the near future, or some other indication of an important or unimportant event associated with the streaming content. The portion of the time window to display the notification can be selected such that the display of the notification is least disruptive to the plot of the streaming content.

By way of example, if within a two minute window for providing a notification that a courier is on the way to the drop-off location with the food, there is expected to be a big plot moment at the one minute forty-five section mark but there is a lull at the twenty-five second mark, the system can determine the twenty-five second mark as the portion of the time window to display the notification.

At operation 415, processing logic can generate the embedding window to render during the portion of the time window. As described herein, the system can determine a particular time at which to provide the notification associated with the order based on plot information, content of a frame of data, or other relevant information.

Processing logic can process the order update data and the current streaming content data to determine a time to display the order update data within the embedding window based on: (i) the order update data and (ii) characteristic data associated with at least one comestible menu item. For instance, the stage of the order update data such as a distinction between a drop-off approaching notification compared to a delivery driver on the way compared to a food item in preparation order update can be taken into account. The various types of notifications can be associated with different expected response times. By way of example, a drop-off approaching or drop-off completed notification can be tagged as more time sensitive than an order in preparation notification.

Characteristic data associated with the at least one comestible menu item can include data indicative of whether the comestible item is a time-sensitive item or not. For instance, a shelf-stable item can be tagged as not time sensitive, as such, notifications associated with shelf-stable items can have a larger time window for determining when to send a notification. Alternatively, time-sensitive items can include cold or hot items like ice cream, gelato, pasta soup, pizza, or other items that may not keep well the longer they are in transport or otherwise unopened.

In some instances, the characteristic data can be indicative of the comestible menu item being at least one of (i) a refrigerated item, (ii) a frozen item, or (iii) a warm item.

Processing logic can, based on the characteristic data being indicative of the comestible menu item being at least one of (i) a refrigerated item, (ii) a frozen item, or (iii) a warm item, update the user interface to provide the order update content in near-real time. As such, the time-sensitive items can be associated with a near real-time order notification. A near real-time order notification can be provided for display within a set number of milliseconds (e.g., five milliseconds, fifty milliseconds, etc.) of receiving the order update data associated with the order notification.

Additionally, or alternatively, the characteristic data can be indicative of an item being shelf stable. Processing logic can, based on the characteristic data being indicative of the item being shelf stable, delay updating the user interface to provide the order update content.

Turning now to FIG. 5, at operation 505, processing logic can determine a first time window for displaying a notification based on a progress associated with the order update.

At operation 510, processing logic can process a number of image frames by for each image frame of the number of image frames, performing operation 515, operation 520, and operation 525.

At operation 515, processing logic can identify a primary subject of the image frame. For instance, a frame can include two characters exchanging dialogue. Either or both of the characters can be determined to be a primary subject of the image frame. In some instances, the primary subject of the image can be determined using image processing. For instance, an image processing model such as a machine-learned model or a large language model can be utilized to extract information about the primary subject of the image frame as well as location of the primary subject within the image frame.

At operation 520, processing logic can identify a portion of the image frame that does not contain the primary subject. By way of example, processing logic can determine a portion of the image frame which includes background image, or otherwise is a portion that does not include a primary subject of the image frame. In some examples, an image processing model such as a machine-learned model can process various frames, scenes, or the entirety of streaming content to determine a location of a primary subject within the respective frames, scenes, or entirety of streaming content.

At operation 525, processing logic can, based on identifying that the portion of the image frame does not contain the primary subject, select the portion as a candidate location within the user interface for the embedding window. A candidate location can include a number of pixels or some other discrete manner of identifying a portion of the user interface in which the embedding window can be generated without causing a visual obstruction to a primary subject of the image frame.

At operation 530, processing logic can select the location for the embedding window based on determining that a number of candidate locations overlap. For instance, processing logic can process a number of sequential image frames to determine a number of candidate embedding window locations. The system can utilize the number of candidate embedding windows, over the frames and determine a selecting embedding window. In some instances, this can be obvious as there can be a complete or near complete (e.g., 90% plus) overlap of the proposed embedding window in the number of image frames. As such, the overlapping portion of pixels or other discrete measure of the screen, can be utilized to generate the embedding window.

In some instances, the location of the embedding window can be generated in near-real time. As such, the embedding window can be generated as the system is requesting an order update notification or responsive to receiving an order update notification.

Alternatively, upon onboarding of streaming content to a streaming content provider, the system can process the content to pre-determine or otherwise generate selected locations for embedding windows within content.

Turning back to FIG. 3, at operation 340, processing logic can generate the embedding window. An embedding window can include a structure including dimensions of the display within which data provided by a third party can be rendered. In some instances, the third party data can be rendered without interacting with the first party content. For example, the third party content can include content associated with the delivery service provider and the first party content can include the streaming content associated with the streaming service. In some instances, the embedding window can include a sandboxed environment such that third party associated with the content rendered within the embedding window cannot directly access information associated with the first party. As such, API calls can be made to provide relevant contextual information to the third party for supplying content to populate the embedding window.

Additionally, or alternatively, the embedding window can be integrated such that the embedding window can perform operations that cause an adjustment to the first party streaming content. The adjustment can occur automatically based on the content of the order notification associated with the third party or can occur responsive to a user selecting a control user interface element (e.g., pause button) rendered within the embedding window.

While the present application describes generating embedding windows for integration between notifications of the delivery service application and the streaming content application, any available means for integrating a third party's content within streaming content of a first party is a reasonable extension of this disclosure. For instance, embedding of an application within another application can include the use of an iFrame, object elements, or any other reasonable means.

At operation 345, processing logic can update the user interface to provide the order update content for display within the embedding window. The content depicted within the embedding window can display stationary or dynamic content. In some instances, the embedding window notification can include simple text assets, additionally or alternatively, the embedding window notification can include graphics, logos, portions of maps, or other related information. For instance, dynamic content can include an interactive map that depicts real-time location data of the courier and progress along the route between the merchant location an drop-off location.

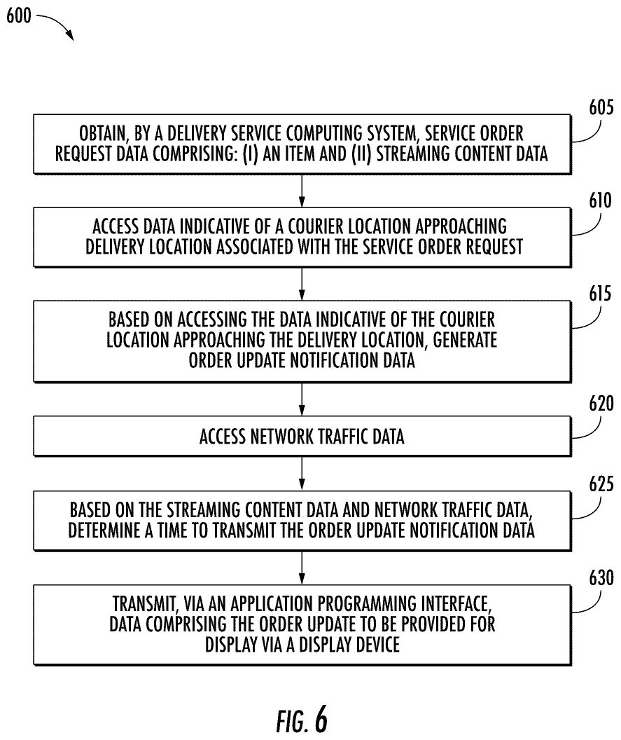

FIG. 6 depicts a flowchart diagram of an example method 600 to perform embedding of notifications into streaming content in accordance with some embodiments of the present disclosure. Method 600 can be performed by processing logic that can include hardware (e.g., computing devices, processing devices, circuitry, programmable logic, dedicated logic, hardware of a device, microcode, integrated circuit, etc.), software (e.g., instructions that are executable or can run on a processing device), or a combination thereof. In some implementations, method 600 can be performed by network computing system (e.g., network system 130) or streaming computing system (e.g., streaming service system 201) which can be a distributed computing system (e.g., cloud-based systems). FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure, and some processes can be performed in parallel. In some embodiments, one or more processes can be omitted. Thus, not all processes are required by every embodiment. Additional or alternative process flows are possible.

At operation 605, processing logic can obtain, by a delivery service computing system, service order request data including: (i) an item and (ii) streaming content data. The service order request data can be obtained via the display device. By way of example, an item can include a comestible menu item, such as a food item, which can be ordered from a merchant. A merchant can include a restaurant, grocery store, convenience store, or other merchant where food items can be purchased.

As described herein, streaming content data can include metadata including at least one of: (i) a title, (ii) frame data, (iii) category data, or (iv) a type of content. The type of content can include at least one of: (i) a movie, (ii) an episode, or (iii) a live program. A title can include a name or other identifier of the streaming content item. Frame data can be data associated with individual frames of the content. This can include text associated with the script in that scene, any sort of tags associated with particular scenes, or any other data relevant to particular frames of the streaming content. A type of content can include an indication of the type or genre of content. Such as a movie, television show, live broadcast, sports, news, comedy, lifestyle, reality television, or any other genre or content type.

At operation 610, processing logic can access data indicative of a courier location approaching a delivery location associated with the service order request. In some instances, the system can determine the location of the courier utilizing location determining hardware of the courier device. Location determining hardware of the courier device can include, for example, global position system (GPS) technology, cell phone towers, motion sensors, environmental sensors, position sensors, Bluetooth connectivity, or any other location determining hardware.

The service order request data can be obtained via a client device. The client device can be a different device from the display device. For instance, the client device can be a cell phone or mobile device that is different from the display device. The display device can be, for example, a television capable of streaming content. By way of example, the television can be connected or “smart” TV or can have a piece of hardware that connects via internet to allow for streaming on the device.

At operation 615, processing logic can, based on accessing the data indicative of the courier location approaching the delivery location, generate order update data. The order update data can include at least one of (i) merchant data or (ii) courier data. Merchant-specific data can include estimated preparation time or other data associated with the merchant. Courier data can include estimated time of arrival to a merchant for pick up of the order or an estimated time of arrival to the drop-off location.

At operation 620, processing logic can access network traffic data. Network traffic data can include an indication of the amount of data that is moving across a network at a particular amount of time. Network traffic data can be accessed for a particular device, a number of devices connected to the same local network, or aggregate network activity for a specific geographical area. For instance, a particular device network traffic data can be broken down into utilization by various applications. Network traffic data for a number of devices connected to the same local network can be allocated among the various devices as well as more granularly within the devices themselves. Aggregate network activity for a specific geographical area can include network utilization broken down by particular applications or streaming services within a geographical area such as a city block, zip code, area code, city, county, state, or region.

As described herein, network traffic data can include network utilization for a streaming service or a delivery service. The network traffic utilization can be used to determine the timing on when to request or transmit order update data. There is a need to provide order updates in a near real-time manner to ensure proper communication without overloading the computing resources of the streaming platform. Additionally, transmission over the network can be controlled to prevent an increase in system latency. As such, determining how to efficiently select data which is transmitted over a network associated with the streaming platform as well as the real-time delivery service can be managed such that latency is reduced and a reduction of computing resource utilization is achieved. The technology described in the present disclosure provides for more efficient usage and allocation of network traffic bandwidth. For example, streaming content services have large amounts of data to push which provides for constrained network communications to deliver content due to the vast amount of network traffic. The technology of the present disclosure can avoid adding to this problem by avoiding pushing continuous or constant notifications.

At operation 625, processing logic can, based on the streaming content data and network traffic data, determine a time to transmit the order update data. By taking into account the streaming content data including characteristics of the content being streamed when deciding when and where to send additional content such as delivery notifications, the technology of the present disclosure provides for improved network traffic bandwidth allocation.

Streaming systems generally preload a portion of streaming content to avoid buffering if network bandwidth is reduced during playback of content. In instances where the system determines an increase in network traffic, the technology of the present disclosure can provide for temporarily stopping streaming communication of video data such that the network bandwidth can be utilized for transmitting delivery notifications. Since there is a portion of the streaming content which is preloaded or locally cached, the streaming content can continue to play the locally cached content while the delivery notifications are being transmitted. This smart selection of network bandwidth utilization can provide for the same or less bandwidth usage while preventing any buffering or suspension of playing streaming content while the delivery notification data is being transmitted between a delivery service system and a display device. Upon completion of transmitting the delivery notification data, the system can resume transmission of the streaming content which can be locally cached on the display device.

At operation 630, processing logic can transmit, via an application programming interface, data including the order update to be provided for display via a display device. The display device can include a client device. The display device can include a television. As such, the order update can be provided in a manner that is integrated within the streaming content such that a user is unaware that the embedding window associated with the order update is not a native function of the streaming content. As such, a seamless user experience can be provided which efficiently utilizes the limited space within the viewport of the display device. As such, the methods described herein help to facilitate the embedding of real-time delivery services within streaming platform content. There are numerous technical challenges with integrating real-time delivery service notifications. For instance, there is a limited amount of display space. The methods described herein provide for displaying additional information within the limited display space while avoiding obstructing other relevant content.

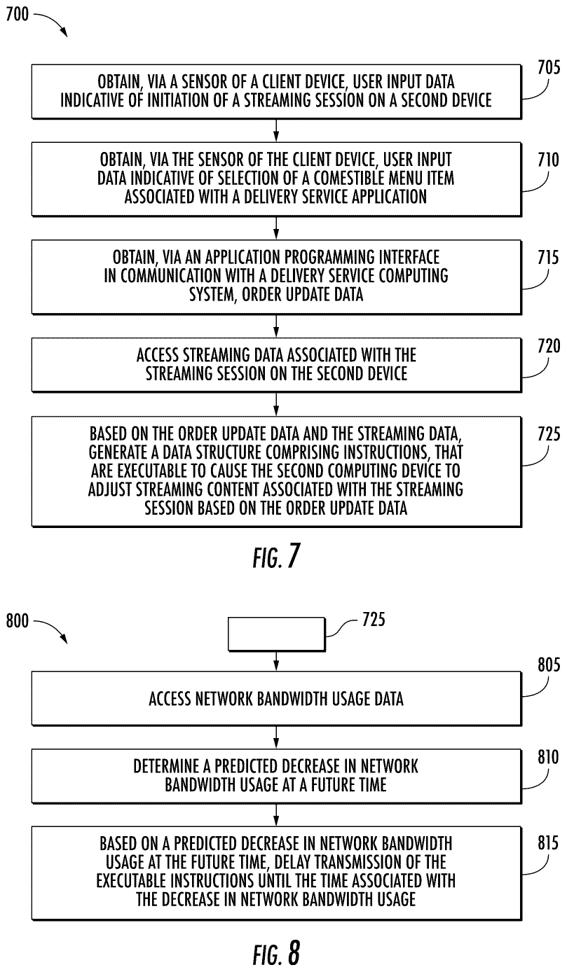

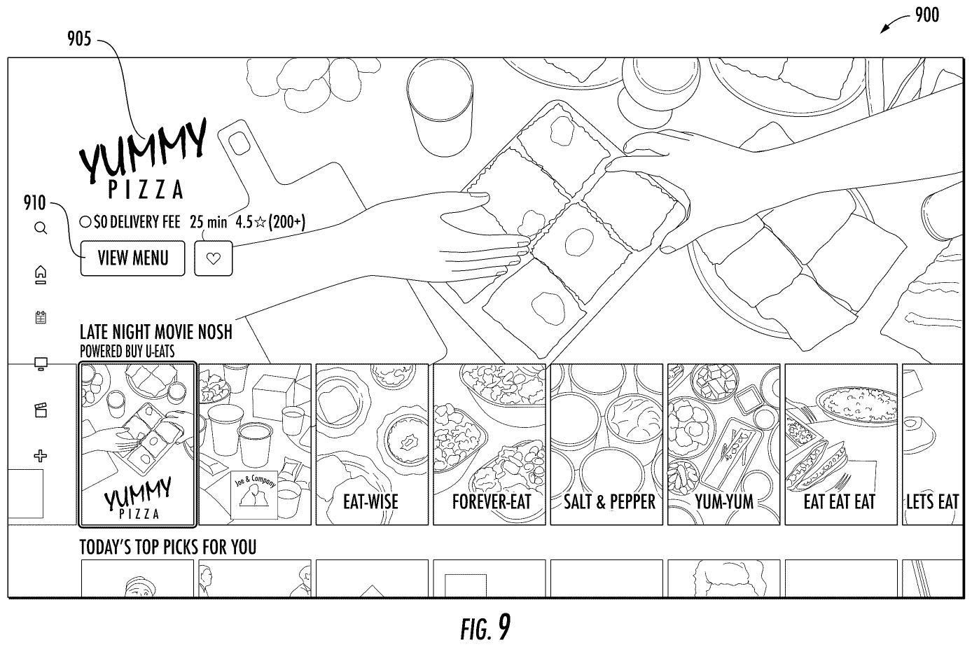

FIG. 7 depicts a flowchart diagram of an example method 700 to perform embedding of notifications into streaming content in accordance with some embodiments of the present disclosure. Method 700 can be performed by processing logic that can include hardware (e.g., computing devices, processing devices, circuitry, programmable logic, dedicated logic, hardware of a device, microcode, integrated circuit, etc.), software (e.g., instructions that are executable or can run on a processing device), or a combination thereof. In some implementations, method 700 can be performed by a network computing system (e.g., network system 130) which can be a distributed computing system (e.g., cloud-based systems). FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure, and some processes can be performed in parallel. In some embodiments, one or more processes can be omitted. Thus, not all processes are required by every embodiment. Additional or alternative process flows are possible.

At operation 705, processing logic can obtain, via a sensor of a client device, user input data indicative of initiation of a streaming session on a second device. For instance, a user can, via an application associated with a delivery service indicate that the user is currently participating in an active streaming session on a secondary device such as a television. In some implementations, processing logic can intelligently determine that a user is participating in an active streaming session based on a collocation of the client device and a display device. As such, the sensor can include a sensor associated with a graphical user interface or a sensor associated with a location determining hardware of the client device.

At operation 710, processing logic can obtain, via the sensor of the client device, user input data indicative of selection of a comestible menu item associated with a delivery service application. By way of example, a user can physically select items to generate a cart associated with the delivery service system. In some instances, a user can request to order items via a voice command such as asking an agent associated with a client device to place an order for one or more food items from a delivery service.

At operation 715, processing logic can obtain, via an application programming interface in communication with a delivery service computing system, order update data. For instance, order update data can include an indication of the progress of the order such as in preparation, picked up by courier, approaching drop-off location, delivered, or some other status. In some instances, order update data can include an estimated time of arrival for the delivery.

At operation 720, processing logic can access streaming data associated with the streaming session on the second device. By way of example, the client device can include a user's mobile device, and the second device can include a television that is displaying the streaming content.

In some implementations, the streaming session and delivery session can be associated with an account identifier. For instance, a user can be logged into an account on the devices. In some instances, a common account or account identifier can be associated with both the streaming session and the delivery session. In some implementations, a user can grant permission for communication between the streaming service and delivery service such that order updates and streaming content data can be shared between the two applications and services.

At operation 725, processing logic can, based on the order update data and the streaming data, generate a data structure including instructions, that are executable to cause the second computing device to adjust streaming content associated with the streaming session based on the order update data. Adjusting the streaming content based on the order update data can include generating an embedding window within the streaming content for providing the order update data for display. Adjusting the streaming content can include pausing the streaming content. In some instances, a user can be provided with a selectable user interface element such as a pause button.

The manner of adjustment of the streaming content can be personalized to a user based on explicit or learned preferences. For instance, a user can set up preferences associated with the account identifier such that certain actions are automatically performed for specific kinds of order updates. Additionally, or alternatively, the system can intelligently learn adjustments to make based on user behavior. For instance, if in response to receiving a notification that the delivery is two minutes out, the user continues to watch the streaming content and waits until being notified that the order has arrived to pause the content, then the system can continue to provide the notification at the two minute mark and automatically pause the content at the time of arrival. As an alternative example, a user can opt for pausing the content upon receiving the two minute notification. As such, the system can intelligently create a mechanism such that when the two minute notification is provided to the user, the system provides a message stating that the content will be automatically paused unless the user takes an action (e.g., selecting an “x” or “continue playing” button on the screen).

Processing logic can provide an order update via a user interface of the client device. For instance, in some cases, a notification of the approaching arrival and the delivery can be provided via the client device of the user and the streaming content can be automatically paused based on the user's interaction with the application on the client device. There are numerous potential examples of intelligent learning and altering actions of the system based on user preferences.

Processing logic can generate a recommended comestible menu item based on the streaming data. By way of example, the system can determine that a particular dish is depicted within the streaming content item. As such, the system can provide recommendations for the user to order the item or ingredients to make the item from a restaurant or a grocery store. Thus, the system can make recommendations and facilitate delivery services for food items which would pair well with, or are depicted in, the streaming content.

Processing logic can provide for display, via the client device, the recommended comestible menu item. In some instances, the recommended comestible menu item can be provided for display in a selectable format such that selection, by a user interfacing with the device, results in the formation of a cart. In some instances, selection of the item can lead to a purchase interface.

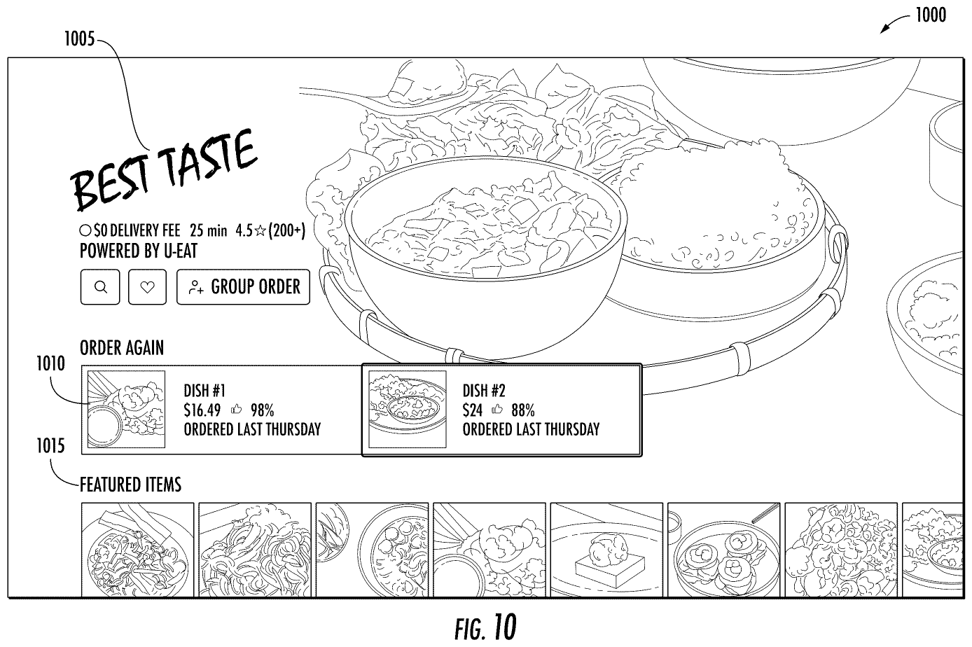

In some instances, method 700 can include method 800 as depicted in FIG. 8.

At operation 805, processing logic can access network bandwidth usage data. For instance, the network traffic data can include network bandwidth usage data.

At operation 810, processing logic can determine a predicted decrease in network bandwidth usage at a future time. For instance, the system can determine that based on a live program such as a football game ending in 30 seconds, that there will be a decrease in aggregate network bandwidth usage based on users turning off their streaming devices.

At operation 815, processing logic can, based on a predicted decrease in network bandwidth usage at the future time, delay transmission of the executable instructions until the time associated with the decrease in network bandwidth usage. As such, the system can determine that a particular order notification, such as an update that items associated with an order have been picked up from a restaurant, can be delayed by 30 seconds to a time when there is less constraint on network bandwidth utilization.

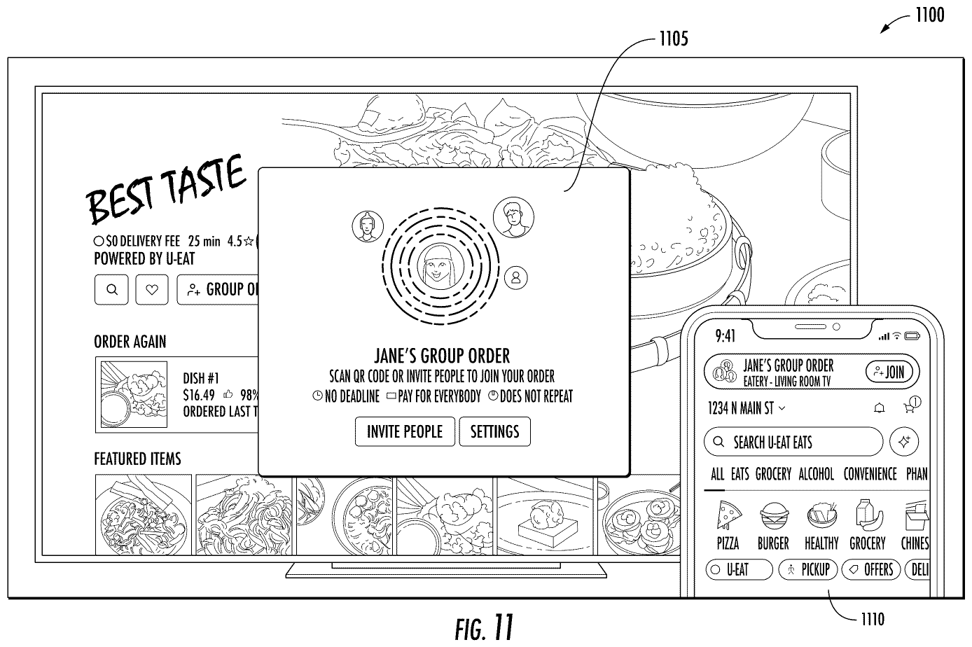

FIG. 9 to FIG. 14 depict example graphical user interfaces according to example embodiments of the present disclosure.

FIG. 9 depicts an example graphical user interface 900. The graphical user interface 900 can include a graphical depiction of a number of candidate merchants including graphics associated with a merchant brand or food items that can be ordered from the merchant. As depicted in FIG. 9, each candidate merchant can be associated with a selectable user interface component. A primary recommended merchant can include a merchant name 905 and a view menu selectable user interface component 910. Upon selection of the user interface component the user interface can be modified to provide a menu associated with the merchant for display.

FIG. 10 depicts an example graphical user interface 1000. The graphical user interface 1000 can include a graphical depiction of a selected merchant 1005. Graphical user interface 1000 can include one or more selectable items 1010. Upon selection of one or more selectable items 1010, the graphical user interface 1000 can be modified to provide a checkout or cart interface. Graphical user interface can include one or more featured items 1015 associated with the merchant.

FIG. 11 depicts an example graphical user interface 1100. The graphical user interface 1100 can be provided for display via a display device. For instance, the display device can be a television. This can allow for initiation of a group ordering session associated with a content streaming session. For instance, responsive to selecting a merchant, a prompt 1105 for initiating a group order can be provided for display via graphical user interface 1100. In some instances, the prompt 1105 can include a QR code or some other manner for users utilizing separate client devices 1110 to join the group order.

In some instances, the computing system can determine that the display device and a client device 1110 are collocated. For instance, the system can determine that the devices are collocated based on Bluetooth, common Wi-Fi connection, or any other means. Responsive to determining that the devices are collocated and that the group order is being initiated on the display device, a user interface associated with the client device 1110 can be modified to provide for display a message to join a group order. The message can include a selectable component such as a “join” button. Responsive to selecting the “join” button, a common cart can be built that includes items added to the cart from the display device or any client devices that have joined the group order.

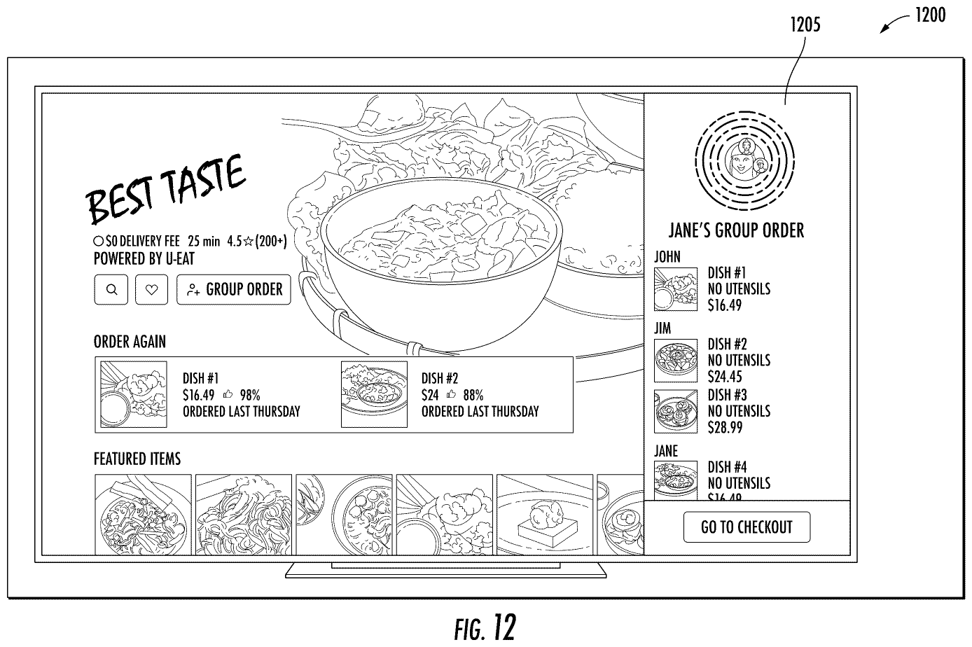

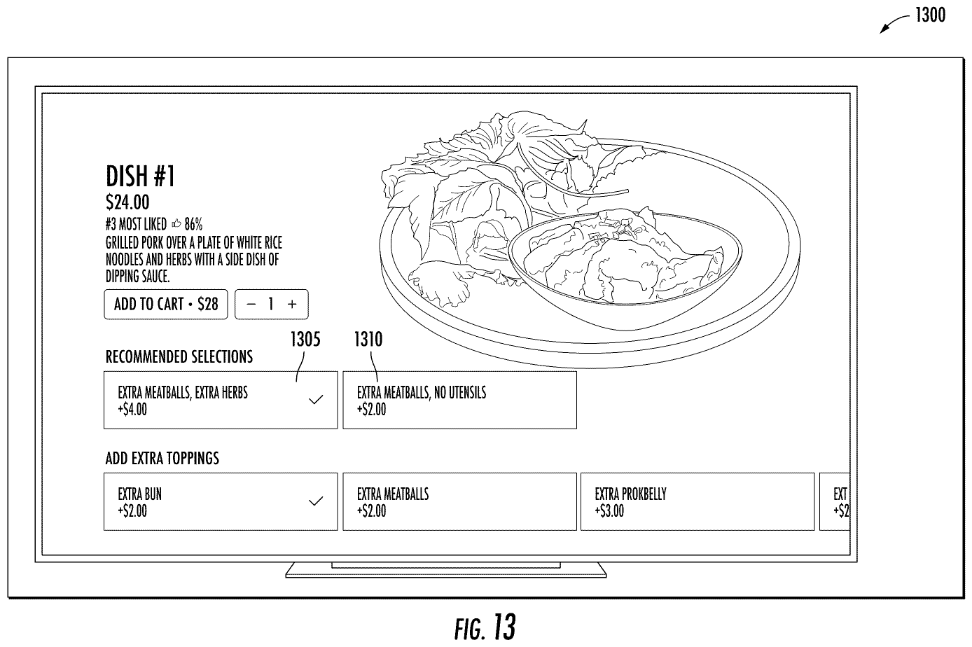

FIG. 12 depicts an example graphical user interface 1200. The graphical user interface 1200 can include a group cart 1205. The group cart can include items added by one or more individuals associated with the group order session. The items can be added via the display device or one or more client devices.

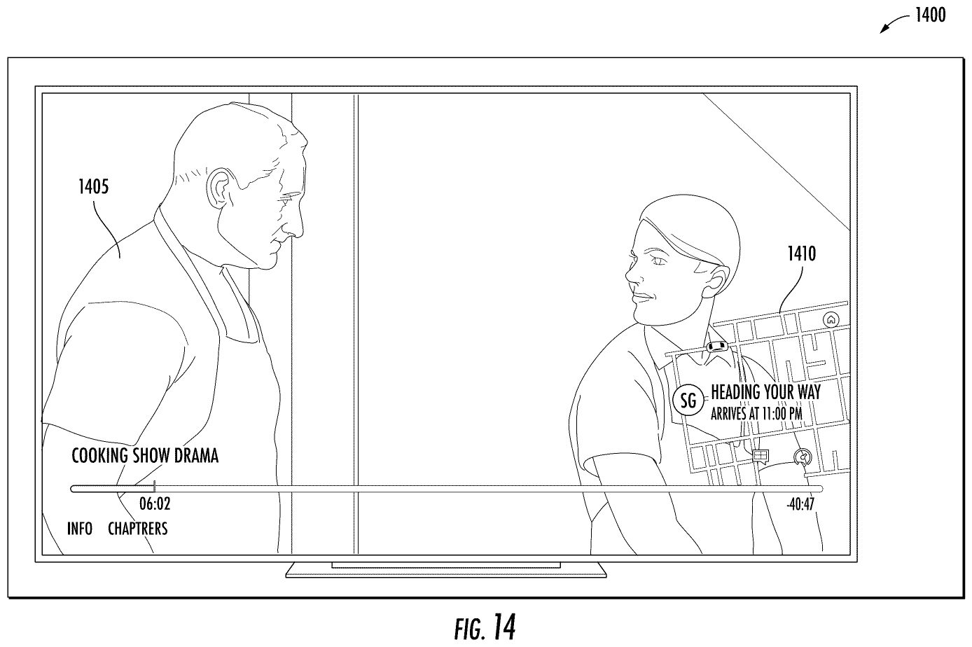

FIG. 13 depicts an example graphical user interface 1300. Due to limited functionality of display devices, it can be beneficial to provide recommendations for dishes with customizations. For instance, based on historical order preferences of a user, a first customization 1305 and a second customization 1310 can be provided. In some instances, the customizations can be generated based on previous orders with a specific merchant, based on preferences or customizations of the user with other merchants, or based on preferences or customizations that are common with customers of the merchant in the aggregate. As such, providing more granular recommendations for customizations can reduce the back-and-forth interaction between a user and the display device. As such, an improved user experience and reduction in processing power utilized by the display device can be reduced. For instance, instead of requiring a user to walk through 4 or 5 user interfaces to make all the customizations for a specific item, the customizations can be initially presented for immediate selection.

In some instances, the recommended items can be generated based on multimodal content processing. For instance, multimodal content processing can be performed to extract information about items within a piece of streaming content. This information can be compared to existing comestible items. If a match or close match is determined, the system can provide a recommendation within a content viewing interface providing the ability to generate a cart or otherwise facilitate order delivery of the item based on interaction within the streaming platform. A match can include an exact match between a term extracted from the multimodal content and an existing comestible item. A close match can be determined based on a similarity of ingredients, cuisines, or some other degree of similarity.

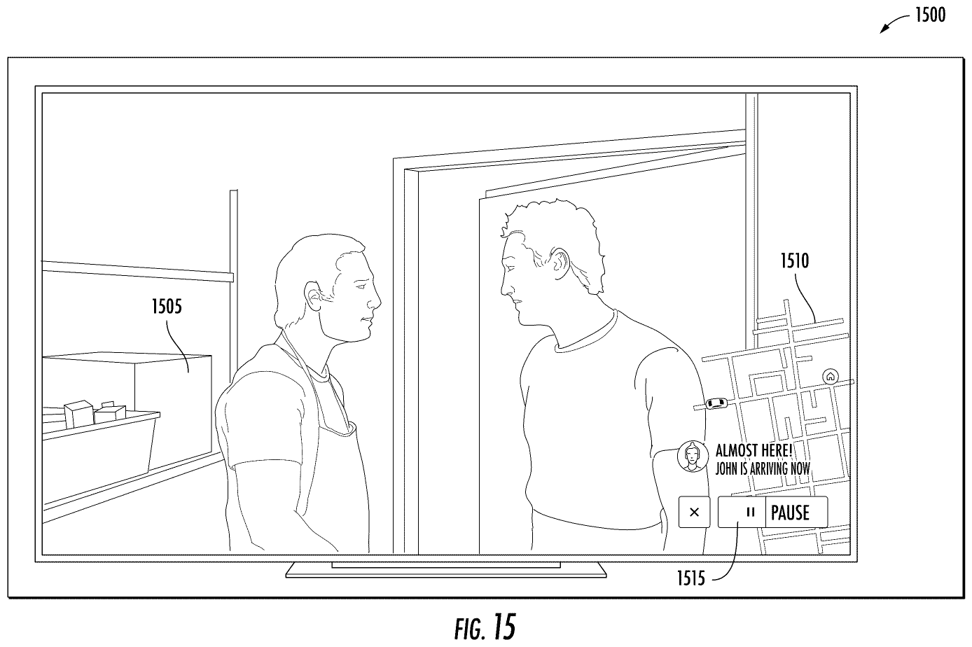

FIG. 14 depicts an example graphical user interface 1400. Graphical user interface 1400 can include a streaming content item 1405 and an order notification embedding window 1410. The order notification embedding window 1410 can be generated as described herein. In some instances, the order notification embedding window 1410 can automatically be provided for display when a control of the content streaming is being altered. For instance, if a user is pausing, rewinding, fast forwarding, or otherwise controlling the streaming content, in addition to the progress bar indicating the control being asserted, the order notification embedding window 1410 can display an order update. As depicted in graphical user interface 1400, order notification embedding window 1410 can include an indication that an order has been picked up and the courier is “heading your way” with a particular arrival time. In some instances, the order notification embedding window 1410 can include a modified map depicting the couriers location in relation to the drop-off location associated with the delivery service order request.

FIG. 15 depicts an example graphical user interface 1500. Graphical user interface 1500 can include streaming content item 1505 and order notification embedding window 1510. As described herein, the system can intelligently determine a timing and location for the order notification embedding window 1510 based on characteristics of the streaming content item and characteristics of the order. For instance, determining that an order is about to arrive can generally trigger the transmission of an order notification from the delivery service system to the streaming content system or the display device. Based on whether the items in the order are time-sensitive items, data associated with the upcoming frames of the streaming content, and network bandwidth utilization, the system can determine whether to immediately provide the order notification for display or to delay. In some instances, order notification embedding window 1510 can include a selectable component 1515, which upon selection, can modify graphical user interface 1500 to pause the streaming content. Additionally, or alternatively, after a set amount of time has passed, the content can automatically be paused based on the order notification update.

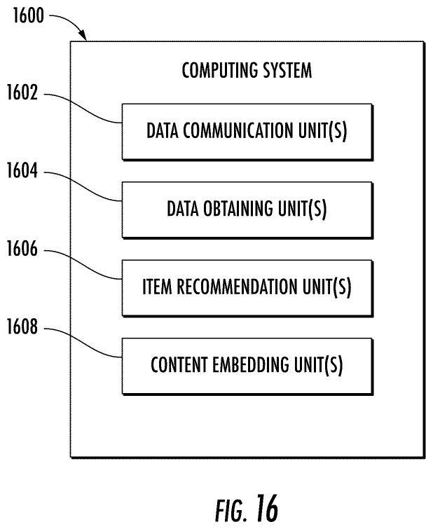

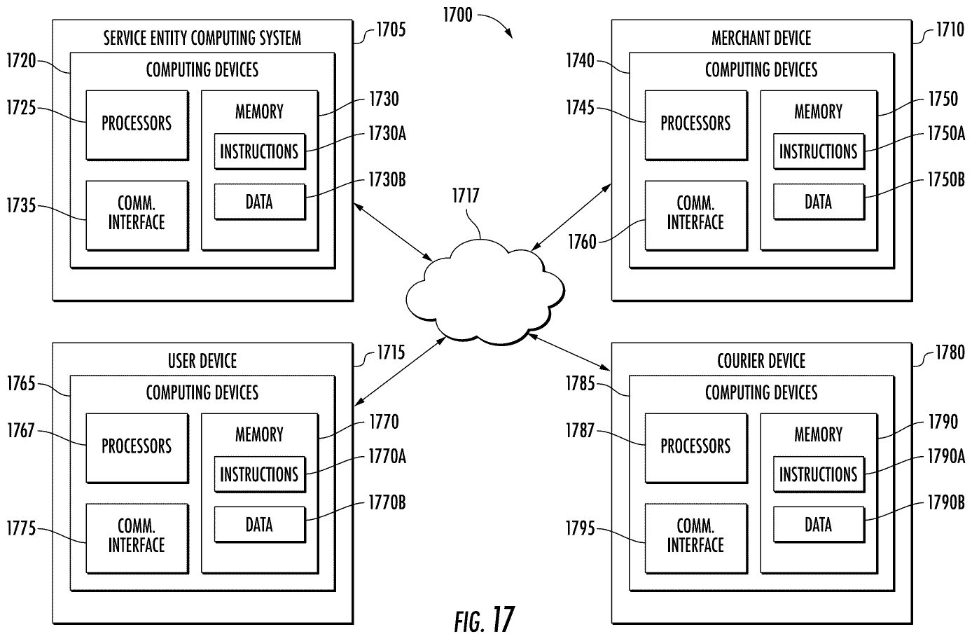

Various means can be configured to perform the methods and processes described herein. For example, FIG. 16 depicts an example computing system 1600 that includes various means according to example embodiments of the present disclosure. The computing system 1600 can be or otherwise include, for example, an operations computing system, etc. The computing system 1600 can include data communication unit(s) 1602, data obtaining unit(s) 1604, item recommendation unit(s) 1606, content embedding unit(s) 1608, or other means for performing the operations and functions described herein. In some implementations, one or more of the units can be implemented separately. In some implementations, one or more units can be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), or other suitable hardware.

The means can be programmed to perform one or more algorithm(s) for carrying out the operations and functions described herein. For instance, the means (e.g., data communication unit(s) 1602) can be configured to communicate data indicative of a request for a courier to perform a delivery service associated with a delivery service request.

In addition, the means (e.g., data obtaining unit(s) 1604) can be configured to obtain data associated with a delivery service request. For example, delivery service request can be indicative of a pick-up location, merchant, item, or drop-off location associated with a delivery service request. In addition, in some implementations, the means (e.g., the data obtaining unit(s) 1604) can obtain data associated with one or more couriers, one or more merchants, or map data indicative of one or more geographic areas.

In addition, the means (e.g., item recommendation unit(s) 1606) can be configured to recommend delivery items based on individual user history, aggregate user history, or other relevant user preference data.

In addition, the means (e.g., content embedding unit(s) 1608) can be configured to determine when and where to generate and populate embedding windows within streaming content items.

These described functions of the means are provided as examples and are not meant to be limiting. The means can be configured for performing any of the operations and functions described herein.

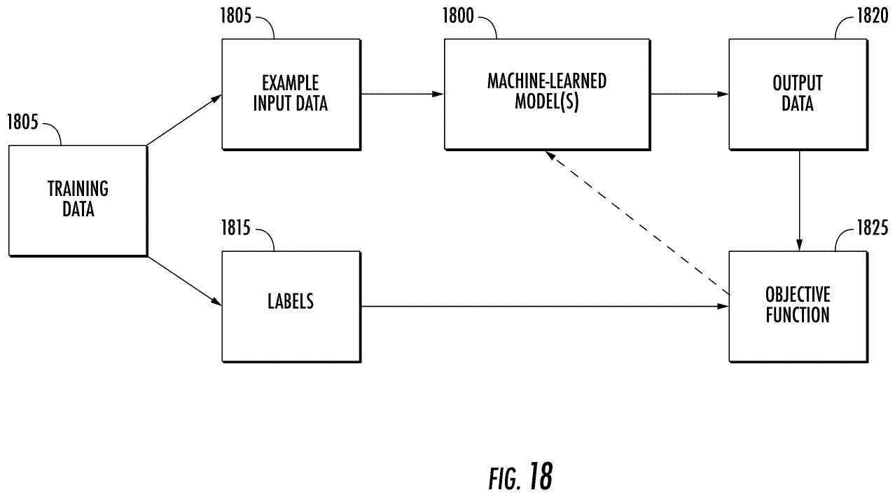

FIG. 17 depicts a block diagram of an example computing system 1700 for implementing systems and methods according to example embodiments of the present disclosure. The example computing system 1700 illustrated in FIG. 17 is provided as an example only. The components, systems, connections, or other aspects illustrated in FIG. 17 are optional and are provided as examples of what is possible, but not required, to implement the present disclosure. The example computing system 1700 can include a service entity computing system 1705 (e.g., that is associated with a delivery service entity). The example computing system 1700 can include one or more merchant devices 1710 (e.g., that is associated with a merchant). The example computing system 1700 can include one or more user devices 1715 (e.g., user device of the user, user device of the operator, user device of the vehicle). The example computing system 1700 can include one or more courier devices (e.g., a mobile device associated with a driver). One or more of the service entity computing system 1705, the merchant device 1710, the user device 1715, or the courier device can be communicatively coupled to one another over one or more communication network(s) 1717. The networks 1717 can correspond to any of the networks described herein.

The computing device(s) 1720 of the service entity computing system 1705 can include processor(s) 1725 and a memory 1730. The one or more processors 1725 can be any suitable processing device (e.g., a processor core, a microprocessor, an ASIC, a FPGA, a controller, a microcontroller) and can be one processor or a number of processors that are operatively connected. The memory 1730 can include one or more non-transitory computer-readable storage media, such as RAM, ROM, EEPROM, EPROM, one or more memory devices, flash memory devices, data registrar, etc., and combinations thereof.

The memory 1730 can store information that can be accessed by the one or more processors 1725. For example, the memory 1730 (e.g., one or more non-transitory computer-readable storage mediums, memory devices) can include computer-readable instructions 1730A that can be executed by the one or more processors 1725. The instructions 1730A can be software written in any suitable programming language or can be implemented in hardware. Additionally, or alternatively, the instructions 1730A can be executed in logically or virtually separate threads on processor(s) 1725.

For example, the memory 1730 can store instructions 1730A that when executed by the one or more processors 1725 cause the one or more processors 1725 (the service entity computing system 1705) to perform operations such as any of the operations and functions of the computing system(s) (e.g., operations computing system) described herein (or for which the computing system(s) are configured), one or more of the operations and functions for communicating between the computing systems, one or more portions/operations of method 300-800, or one or more of the other operations and functions of the computing systems described herein.

The memory 1730 can store data 1730B that can be obtained (e.g., acquired, received, retrieved, accessed, created, stored). The data 1730B can include, for example, any of the data/information described herein. In some implementations, the computing device(s) 1720 can obtain data from one or more memories that are remote from the service entity computing system 1705.

The computing device(s) 1720 can also include a communication interface 1735 used to communicate with one or more other system(s) remote from the service entity computing system 1705, such as merchant device 1710, user device 1715, or courier device 1780. The communication interface 1735 can include any circuits, components, software, etc. for communicating via one or more networks (e.g., network(s) 1717). The communication interface 1735 can include, for example, one or more of a communications controller, receiver, transceiver, transmitter, port, conductors, software or hardware for communicating data.

The merchant device 1710 can include one or more computing device(s) 1740 that are remote from the service entity computing system 1705, the user device 1715, and the courier device 1780. The computing device(s) 1740 can include one or more processors 1745 and a memory 1750. The one or more processors 1745 can be any suitable processing device (e.g., a processor core, a microprocessor, an ASIC, a FPGA, a controller, a microcontroller) and can be one processor or a number of processors that are operatively connected. The memory 1750 can include one or more tangible, non-transitory computer-readable storage media, such as RAM, ROM, EEPROM, EPROM, one or more memory devices, flash memory devices, data registrar, etc., and combinations thereof.

The memory 1750 can store information that can be accessed by the one or more processors 1745. For example, the memory 1750 (e.g., one or more tangible, non-transitory computer-readable storage media, one or more memory devices) can include computer-readable instructions 1750A that can be executed by the one or more processors 1745. The instructions 1750A can be software written in any suitable programming language or can be implemented in hardware. Additionally, or alternatively, the instructions 1750A can be executed in logically or virtually separate threads on processor(s) 1745.

For example, the memory 1750 can store instructions 1750A that when executed by the one or more processors 1745 cause the one or more processors 1745 to perform operations such as any of the operations and functions of the computing system(s) (e.g., merchant server) described herein (or for which the computing system(s) are configured), one or more of the operations and functions for communicating between computing systems, one or more portions/operations of method 300-800, or one or more of the other operations and functions of the computing systems described herein. The memory 1750 can store data 1750B that can be obtained. The data 1750B can include, for example, any of the data/information described herein.

The computing device(s) 1740 can also include a communication interface 1760 used to communicate with one or more system(s) that are remote from the merchant device 1710. The communication interface 1760 can include any circuits, components, software, etc. for communicating via one or more networks (e.g., network(s) 1717). The communication interface 1760 can include, for example, one or more of a communications controller, receiver, transceiver, transmitter, port, conductors, software or hardware for communicating data.

The user device 1715 can include one or more computing device(s) 1765 that are remote from the service entity computing system 1705, the merchant device 1710, and the courier device 1780. The computing device(s) 1765 can include one or more processors 1767 and a memory 1770. The one or more processors 1767 can be any suitable processing device (e.g., a processor core, a microprocessor, an ASIC, a FPGA, a controller, a microcontroller) and can be one processor or a number of processors that are operatively connected. The memory 1770 can include one or more tangible, non-transitory computer-readable storage media, such as RAM, ROM, EEPROM, EPROM, one or more memory devices, flash memory devices, data registrar, etc., and combinations thereof.

The memory 1770 can store information that can be accessed by the one or more processors 1767. For example, the memory 1770 (e.g., one or more tangible, non-transitory computer-readable storage media, one or more memory devices) can include computer-readable instructions 1770A that can be executed by the one or more processors 1767. The instructions 1770A can be software written in any suitable programming language or can be implemented in hardware. Additionally, or alternatively, the instructions 1770A can be executed in logically or virtually separate threads on processor(s) 1767.

For example, the memory 1770 can store instructions 1770A that when executed by the one or more processors 1767 cause the one or more processors 1767 to perform operations such as any of the operations and functions of the computing system(s) (e.g., user devices) described herein (or for which the user device(s) are configured), one or more of the operations and functions for communicating between systems, one or more portions/operations of method 300-800, or one or more of the other operations and functions of the computing systems described herein. The memory 1770 can store data 1770B that can be obtained. The data 1770B can include, for example, any of the data/information described herein.

The computing device(s) 1765 can also include a communication interface 1775 used to communicate computing device/system that is remote from the user device 1715, such as merchant device 1710, service entity computing system 1705, or courier device 1780. The communication interface 1775 can include any circuits, components, software, etc. for communicating via one or more networks (e.g., network(s) 1717). The communication interface 1775 can include, for example, one or more of a communications controller, receiver, transceiver, transmitter, port, conductors, software or hardware for communicating data.

The computing device(s) 1785 of the courier device 1780 can include processor(s) 1787 and a memory 1790. The one or more processors 1787 can be any suitable processing device (e.g., a processor core, a microprocessor, an ASIC, a FPGA, a controller, a microcontroller) and can be one processor or a number of processors that are operatively connected. The memory 1790 can include one or more non-transitory computer-readable storage media, such as RAM, ROM, EEPROM, EPROM, one or more memory devices, flash memory devices, data registrar, etc., and combinations thereof.

The memory 1790 can store information that can be accessed by the one or more processors 1787. For example, the memory 1790 (e.g., one or more non-transitory computer-readable storage mediums, memory devices) can include computer-readable instructions 1790A that can be executed by the one or more processors 1787. The instructions 1790A can be software written in any suitable programming language or can be implemented in hardware. Additionally, or alternatively, the instructions 1790A can be executed in logically or virtually separate threads on processor(s) 1787.

For example, the memory 1790 can store instructions 1790A that when executed by the one or more processors 1787 cause the one or more processors 1787 (the courier device 1780) to perform operations such as any of the operations and functions of the display device(s) described herein (or for which such devices are configured), one or more of the operations and functions for communicating between the computing systems/devices, one or more portions/operations of method 300-800, or one or more of the other operations and functions of the computing systems described herein.

The memory 1790 can store data 1790B that can be obtained (e.g., acquired, received, retrieved, accessed, created, stored). The data 1790B can include, for example, any of the data/information described herein. In some implementations, the computing device(s) 1785 can obtain data from one or more memories that are remote from the courier device 1780.

The computing device(s) 1785 can also include a communication interface 1795 used to communicate with one or more other system(s) remote from the courier device 1780, such as merchant device 1710, user device 1715, or service entity computing system 1705. The communication interface 1795 can include any circuits, components, software, etc. for communicating via one or more networks (e.g., network(s) 1717). The communication interface 1795 can include, for example, one or more of a communications controller, receiver, transceiver, transmitter, port, conductors, software or hardware for communicating data.

The network(s) 1717 can be any type of network or combination of networks that allows for communication between devices. In some implementations, the network(s) 1717 can include one or more of a local area network, wide area network, the Internet, secure network, cellular network, mesh network, peer-to-peer communication link or some combination thereof and can include any number of wired or wireless links. Communication over the network(s) 1717 can be accomplished, for example, via a communication interface using any type of protocol, protection scheme, encoding, format, packaging, etc.

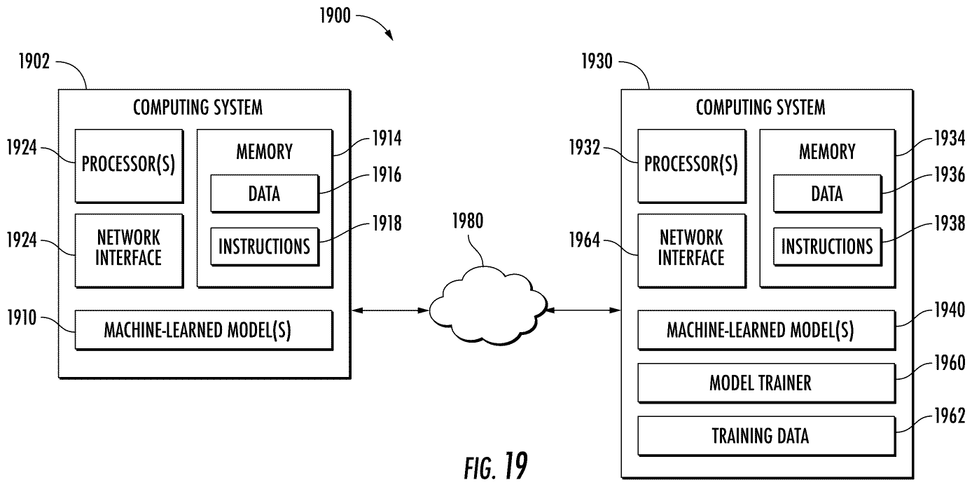

FIG. 18 illustrates a block diagram of an example training process in which a machine-learned model 1800 is trained on training data 1805 that includes example input data 1810 that has labels 1815. Training processes other than the example process depicted in FIG. 18 can be used as well. Machine-learned models 1800 can include embedding window generation model, a notification timing model, or a dish recommendation model.

Models can include content processing model, similar dish model, or embedding model. In some instances, the machine-learned model can include a content processing model. For instance, the content processing model can process input including a number of modalities such as video, image, audio, or text. The multimodal processing model can perform a fusion of data from multimodalities such as audio, text, image, video, or any other modality. In some instances, combining information can include fusion-based approaches, alignment-based approaches, or later fusion to generate high-dimensional representations that capture semantic information associated with the data of each respective modality.

A fusion-based approach can provide for encoding different modalities of information into a common representation space such as a multi-dimensional embedding space. An example implementation of a fusion-based approach can include applications such as audio-visual speech recognition.

An alignment-based approach can provide for aligning different modalities such that the respective modalities can be directly compared. For instance, an alignment-based approach can include processing audio information and video information associated with an audio-visual content item and aligning the two to determine the subject of the audio-visual content.

A late fusion approach can involve combining the predictions from models trained on each respective modality separately. For instance, a late fusion approach can include processing data from each respective modality and then combining the individual predictions.

In some instances, multimodal processing models can include translation components. The translation components can provide for translating input data from a first modality to a second modality such that the data can be processed. Additionally, or alternatively, the methods can include co-learning which can provide for transferring knowledge learned by one model or associated with one modality to tasks involving other models or other modalities.

In some instances, multimodal processing can be performed with machine-learned models. By way of example, the machine-learned models can include a neural network. In some instances, the machine-learned model can include a generative model such as a large language model.

The models described herein are provided for exemplary purposes only and are not meant to be limited. Any of the above models can be models 1800. In some instances, models can be a single model. In some instances, models can be distinct models. In some instances, the models can be a combination of various kinds of machine-learned models with unique architecture and training methods. For instances, some models can be trained using supervised or unsupervised learning. In some instances, the models can be trained on delivery service specific training data. In some instances, the models can be trained based on comestible item content item specific training data to improve the extraction of comestible item features and dish data from the content items.

Content processing model can include one or more models capable of processing one or more modes of data. For instance, content processing model can process images, videos, text, or audio data to extract features associated with content items. The extracted features can be utilized by other models or components of the computing system to perform actions such as cuisine categorization, video recommendation, similar dish recommendation, generation of ingredients or recipes, deliverability status determination components, or any other models or components. For instance, the content processing model can process a video of a burrito bowl being made. The video can include a voice over describing the different ingredients added to the bowl such as rice, beans, chicken, salsa, cheese, and guacamole. The content processing model can process the image to determine the items that are being added, the order in which the items are added, or instructions for preparing any of the items.

Similar dish model can obtain feature data or cuisine categorization data to determine one or more similar dishes or items to those depicted in the content item. In some instances, a content item can provide an item which has been ordered.

In some implementations, the machine-learned models described herein can be trained at a training computing system and then provided for storage or implementation at one or more computing devices, as described above. For example, a model trainer can be located at the training computing system. The training computing system can be included in or separate from the one or more computing devices that implement the machine-learned model. In some implementations, the model can be trained in an offline fashion or an online fashion. In offline training (also known as batch learning), a model is trained on the entirety of a static set of training data. In online learning, the model is continuously trained (or re-trained) as new training data becomes available (e.g., while the model is used to perform inference).

In some implementations, the model trainer can perform centralized training of the machine-learned models (e.g., based on a centrally stored dataset). In other implementations, decentralized training techniques such as distributed training, federated learning, or the like can be used to train, update, or personalize the machine-learned models.

The machine-learned models described herein can be trained according to one or more of various different training types or techniques. For example, in some implementations, the machine-learned models can be trained using supervised learning, in which the machine-learned model is trained on a training dataset that includes instances or examples that have labels. The labels can be manually applied by experts, generated through crowd-sourcing, or provided by other techniques (e.g., by physics-based or complex mathematical models). In some implementations, if the user has provided consent, the training examples can be provided by the user computing device. In some implementations, this process can be referred to as personalizing the model.

In some implementations, training data 1805 can include examples of the input data 1810 that have been assigned labels 1815 that correspond to the output data 1820. For example, extracting features from multimodal content items can be performed using a multimodal processing model that is trained using multimodal content training data gathered by the computing system. This multimodal content training data can include data associated with content items. The data associated with the content items can include metadata such as include categorization data, extracted feature data, creator information, time data, freshness data, or performance data.

In some implementations, during training, the input training data can be intentionally deformed in any number of ways to increase model robustness, generalization, or other qualities. Example techniques to deform the training data include adding noise; changing color, shade, or hue; magnification; segmentation; amplification; etc.

In some implementations, the machine-learned model 1800 can be trained by optimizing an objective function 1825. For example, in some implementations, the objective function 1825 can be or include a loss function that compares (e.g., determines a difference between) output data generated by the model from the training data 1805 and labels 1815 (e.g., ground-truth labels) associated with the training data 1805. For example, the loss function can evaluate a sum or mean of squared differences between the output data and the labels. As another example, the objective function 1825 can be or include a cost function that describes a cost of a certain outcome or output data 1820. Other objective functions can include margin-based techniques such as, for example, triplet loss or maximum-margin training.

One or more of various optimization techniques can be performed to optimize the objective function 1825. For example, the optimization technique(s) can minimize or maximize the objective function 1825. Example optimization techniques include Hessian-based techniques and gradient-based techniques, such as, for example, coordinate descent; gradient descent (e.g., stochastic gradient descent); subgradient methods; etc. Other optimization techniques include black box optimization techniques and heuristics.

In some implementations, backward propagation of errors can be used in conjunction with an optimization technique (e.g., gradient based techniques) to train a model (e.g., a multi-layer model such as an artificial neural network). For example, an iterative cycle of propagation and model parameter (e.g., weights) update can be performed to train the model. Example backpropagation techniques include truncated backpropagation through time, Levenberg-Marquardt backpropagation, etc.

In some implementations, the machine-learned models described herein can be trained using unsupervised learning techniques. Unsupervised learning can include inferring a function to describe hidden structure from unlabeled data. For example, a classification or categorization can not be included in the data. Unsupervised learning techniques can be used to produce machine-learned models capable of performing clustering, anomaly detection, learning latent variable models, or other tasks.

In some implementations, the machine-learned models described herein can be trained using semi-supervised techniques which combine aspects of supervised learning and unsupervised learning.

In some implementations, the machine-learned models described herein can be trained or otherwise generated through evolutionary techniques or genetic algorithms.

In some implementations, the machine-learned models described herein can be trained using reinforcement learning. In reinforcement learning, an agent (e.g., model) can take actions in an environment and learn to maximize rewards or minimize penalties that result from such actions. Reinforcement learning can differ from the supervised learning problem in that correct input/output pairs are not presented, nor sub-optimal actions explicitly corrected.

In some implementations, one or more generalization techniques can be performed during training to improve the generalization of the machine-learned model. Generalization techniques can help reduce overfitting of the machine-learned model to the training data. Example generalization techniques include dropout techniques; weight decay techniques; batch normalization; early stopping; subset selection; stepwise selection; etc.

In some implementations, the machine-learned models described herein can include or otherwise be impacted by a number of hyperparameters, such as, for example, learning rate, number of layers, number of nodes in each layer, number of leaves in a tree, number of clusters; etc. Hyperparameters can affect model performance. Hyperparameters can be hand selected or can be automatically selected through application of techniques such as, for example, grid search; black box optimization techniques (e.g., Bayesian optimization, random search); gradient-based optimization; etc. Example techniques or tools for performing automatic hyperparameter optimization include Hyperopt; Auto-WEKA; Spearmint; Metric Optimization Engine (MOE); etc.

In some implementations, various techniques can be used to optimize or adapt the learning rate when the model is trained. Example techniques or tools for performing learning rate optimization or adaptation include Adagrad; Adaptive Moment Estimation (ADAM); Adadelta; RMSprop; etc.

In some implementations, transfer learning techniques can be used to provide an initial model from which to begin training of the machine-learned models described herein.

FIG. 19 depicts a block diagram of an example computing system 1900 according to example embodiments of the present disclosure. The example system 1900 includes a computing system 1902 and a machine learning computing system 1930 that are communicatively coupled over a network 1980.

In some implementations, the computing system 1902 can generate recommended items such as prepared items or recipes of items. In some implementations, the computing system 1902 can be included in a device associated with a food delivery service entity. In some instances, the computing system 1902 can operate offline to perform dynamic suggestions prepared items or recipes and ingredient lists to provide order suggestions to a user. The computing system 1902 can include one or more distinct physical computing devices.

The computing system 1902 includes one or more processors 1912 and a memory 1914. The one or more processors 1912 can be any suitable processing device (e.g., a processor core, a microprocessor, an ASIC, a FPGA, a controller, a microcontroller) and can be one processor or a number of processors that are operatively connected. The memory 1914 can include one or more non-transitory computer-readable storage media, such as RAM, ROM, EEPROM, EPROM, one or more memory devices, flash memory devices, etc., and combinations thereof.

The memory 1914 can store information that can be accessed by the one or more processors 1912. For instance, the memory 1914 (e.g., one or more non-transitory computer-readable storage mediums, memory devices) can store data 1916 that can be obtained, received, accessed, written, manipulated, created, or stored. The data 1916 can include, for instance, user data, historical data, merchant data or content item data. In addition, or alternatively the data 1916 can include, for instance, data associated with a number of content items, prepared items, or recipes and ingredient lists.

In some implementations, the computing system 1902 can obtain data from one or more memory device(s) that are remote from the system 1902.

The memory 1914 can also store computer-readable instructions 1918 that can be executed by the one or more processors 1912. The instructions 1918 can be software written in any suitable programming language or can be implemented in hardware. Additionally, or alternatively, the instructions 1918 can be executed in logically or virtually separate threads on processor(s) 1912.

For example, the memory 1914 can store instructions 1918 that when executed by the one or more processors 1912 cause the one or more processors 1912 to perform any of the operations or functions described herein, including, for example, operations depicted in FIG. 4 to FIG. 9.

According to an aspect of the present disclosure, the computing system 1902 can store or include one or more machine-learned models 1910. As examples, the machine-learned models 1910 can be or can otherwise include various machine-learned models such as, for example, neural networks (e.g., deep neural networks), support vector machines, decision trees, ensemble models, k-nearest neighbors models, Bayesian networks, or other types of models including linear models or non-linear models. Example neural networks include feed-forward neural networks, convolutional neural networks, recurrent neural networks (e.g., long short-term memory recurrent neural networks), or other forms of neural networks.

In some implementations, the computing system 1902 can receive the one or more machine-learned models 1910 from the machine learning computing system 1930 over network 1980 and can store the one or more machine-learned models 1910 in the memory 1914. The computing system 1902 can then use or otherwise implement the one or more machine-learned models 1910 (e.g., by processor(s) 1912). In particular, the computing system 1902 can implement the machine-learned model(s) 1910 to perform merchant ranking or fulfillment cost prediction. For example, in some implementations, the computing system 1902 can employ the machine-learned model(s) 1910 by inputting multiple time frames of multimodal data such as image, audio, or text data into the machine-learned model(s) 1910 and receiving output data such as prepared items or recipes as an output of the machine-learned model(s) 1910.

The machine learning computing system 1930 includes one or more processors 1932 and a memory 1934. The one or more processors 1932 can be any suitable processing device (e.g., a processor core, a microprocessor, an ASIC, a FPGA, a controller, a microcontroller) and can be one processor or a number of processors that are operatively connected. The memory 1934 can include one or more non-transitory computer-readable storage media, such as RAM, ROM, EEPROM, EPROM, one or more memory devices, flash memory devices, etc., and combinations thereof.

The memory 1934 can store information that can be accessed by the one or more processors 1932. For instance, the memory 1934 (e.g., one or more non-transitory computer-readable storage mediums, memory devices) can store data 1936 that can be obtained, received, accessed, written, manipulated, created, or stored. The data 1936 can include, for instance, user data, historical data, merchant data or content item data. In addition, or alternatively the data 1936 can include, for instance data associated with a number of content items, prepared items, or recipes and ingredient lists. In some implementations, the machine learning computing system 1930 can obtain data from one or more memory device(s) that are remote from the system 1930.

The memory 1934 can also store computer-readable instructions 1938 that can be executed by the one or more processors 1932. The instructions 1938 can be software written in any suitable programming language or can be implemented in hardware. Additionally, or alternatively, the instructions 1938 can be executed in logically or virtually separate threads on processor(s) 1932.

For example, the memory 1934 can store instructions 1938 that when executed by the one or more processors 1932 cause the one or more processors 1932 to perform any of the operations or functions described herein, including, for example, the operations depicted in FIG. 3 to FIG. 8.

In some implementations, the machine learning computing system 1930 includes one or more server computing devices. If the machine learning computing system 1930 includes multiple server computing devices, such server computing devices can operate according to various computing architectures, including, for example, sequential computing architectures, parallel computing architectures, or some combination thereof.

In addition, or alternatively to the model(s) 1910 at the computing system 1902, the machine learning computing system 1930 can include one or more machine-learned models 1940. As examples, the machine-learned models 1940 can be or can otherwise include various machine-learned models such as, for example, neural networks (e.g., deep neural networks), support vector machines, decision trees, ensemble models, k-nearest neighbors models, Bayesian networks, or other types of models including linear models or non-linear models. Example neural networks include feed-forward neural networks, convolutional neural networks, recurrent neural networks (e.g., long short-term memory recurrent neural networks), generative neural networks, or other forms of neural networks.

By way of example, the machine-learned model can include a generative adversarial network (GAN), variational autoencoder (VAE), autoregressive models, flow-based models, transformer-based models, or any other machine-learned models.

Generative adversarial networks (GANs) can be a type of deep learning model that uses two neural networks including a generator and a discriminator. The generator can create data that tries to mimic real data while the discriminator attempts to distinguish between the real and generated data. By training the generator and discriminator against each other, GANs can generate realistic data.

Variational autoencoders (VAEs) can encode input data into a latent space. A latent space can include a lower-dimensional representation, compact representation of the data. The latent space can be decoded into the original data. By learning the distribution of the latent space, VAEs can generate new data by sampling from the distribution and decoding the samples.

Autoregressive models can generate data sequentially, one element at a time. The autoregressive models can predict a next element in a sequence based on the previously generated elements. As such, the autoregressive models can capture complex dependencies within the data and can be utilized in various applications such as text generation or image synthesis.

Flow-based models can use invertible functions to transform data from a simple distribution to a complex distribution. As such, flow-based models can generate high quality samples efficiently and can learn underlying data distributions accurately. In some instances, flow-based models can be used to generate training data for machine-learned models. Some applications of flow-based models can include image generation, audio synthesis, or natural language generation.

Transformer-based models can be a type of neural network architecture that is good for natural language processing. Transformer-based models can utilize self-attention to process input sequences which can allow the models to utilize the context of the input including long-range dependencies and relationships within the input data. As such, transformer-based models can be utilized for summarization, translation, question answering, or other relevant applications.

As an example, the machine learning computing system 1930 can communicate with the computing system 1902 according to a client-server relationship. For example, the machine learning computing system 1930 can implement the machine-learned models 1940 to provide a web service to the computing system 1902. For example, the web service can provide an autonomous vehicle motion planning service.

Thus, machine-learned models 1910 can be located and used at the computing system 1902 or machine-learned models 1940 can be located and used at the machine learning computing system 1930.

In some implementations, the machine learning computing system 1930 or the computing system 1902 can train the machine-learned models 1910 or 1940 through use of a model trainer 1960. The model trainer 1960 can train the machine-learned models 1910 or 1940 using one or more training or learning algorithms. One example training technique is backwards propagation of errors. In some implementations, the model trainer 1960 can perform supervised training techniques using a set of labeled training data. In other implementations, the model trainer 1960 can perform unsupervised training techniques using a set of unlabeled training data. The model trainer 1960 can perform a number of generalization techniques to improve the generalization capability of the models being trained. Generalization techniques include weight decays, dropouts, or other techniques.

In particular, the model trainer 1960 can train a machine-learned model 1910 or 1940 based on a set of training data 1962. The training data 1962 can include, for example, a number of sets of ground truth data, each set of ground truth data including a first portion and a second portion. For example, the training data 1962 can include a large number of previously obtained multimodal content items, feature data extracted from the multimodal content items, prepared dishes, or recipes and ingredient lists associated with a multimodal content item.

In one implementation, the training data 1962 can include a first portion of data corresponding to instances of an order associated with a recommended prepared dish or list of ingredients being placed, an order associated with a recommended prepared dish or list of ingredients not being placed, or a user interacting with suggested merchants or items associated with the recommended prepared dish or list of ingredients. The data can be labeled indicating if an order was or was not placed or if the user interacted with one or more suggested items (and information about the interaction, e.g., length of viewing, data associated with the one or more items viewed). The labels included within the second portion of data within the training data 1962 can be manually annotated, automatically annotated, or annotated using a combination of automatic labeling and manual labeling.

In some implementations, to train the machine-learned model (e.g., machine-learned model(s) 1910 or 1940), model trainer 1960 can input a first portion of a set of ground-truth data (e.g., the first portion of the training data 1962 corresponding to the one or more representations of recommended item order conversions) into the models (e.g., machine-learned model(s) 1910 or 1940) to be trained. In response to receipt of such first portion, the machine-learned model outputs recommended prepared items or recipes and associated ingredient lists. In response to receipt of such first portion, the machine-learned model outputs a probability associated with a confidence score for the one or more recommended items. This output of the machine-learned models predicts the remainder of the set of ground-truth data (e.g., the second portion of the training dataset). After such prediction, the model trainer 1960 can apply or otherwise determine a loss function that compares the output data of the one or more machine-learned models (e.g., machine-learned models 1910 or 1940) to the remainder of the ground-truth data which the models attempted to predict. The model trainer 1960 then can backpropagate the loss function through the model(s) (e.g., machine-learned model(s) 1910 or 1940) to train the model(s) (e.g., by modifying one or more weights associated with the model(s)). This process of inputting ground-truth data, determining a loss function, and backpropagating the loss function through the model can be repeated numerous times as part of training the model. For example, the process can be repeated for each of numerous sets of ground-truth data provided within the training data 1962. The model trainer 1960 can be implemented in hardware, firmware, or software controlling one or more processors.

The computing system 1902 can also include a network interface 1924 used to communicate with one or more systems or devices, including systems or devices that are remotely located from the computing system 1902. The network interface 1924 can include any circuits, components, software, etc. for communicating with one or more networks (e.g., 1980). In some implementations, the network interface 1924 can include, for example, one or more of a communications controller, receiver, transceiver, transmitter, port, conductors, software, or hardware for communicating data. Similarly, the machine learning computing system 1930 can include a network interface 1964.

The network(s) 1980 can be any type of network or combination of networks that allows for communication between devices. In some embodiments, the network(s) can include one or more of a local area network, wide area network, the Internet, secure network, cellular network, mesh network, peer-to-peer communication link, or some combination thereof, and can include any number of wired or wireless links. Communication over the network(s) 1980 can be accomplished, for instance, via a network interface using any type of protocol, protection scheme, encoding, format, packaging, etc.

FIG. 19 illustrates one example computing system 1900 that can be used to implement the present disclosure. Other computing systems can be used as well. For example, in some implementations, the computing system 1902 can include the model trainer 1960 and the training dataset 1962. In such implementations, the machine-learned models 1910 can be both trained and used locally at the computing system 1902. As another example, in some implementations, the computing system 1902 is not connected to other computing systems.

In addition, components illustrated or discussed as being included in one of the computing systems 1902 or 1930 can instead be included in another of the computing systems 1902 or 1930. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

Computing tasks discussed herein as being performed at certain computing device(s)/systems can instead be performed at another computing device/system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implements tasks or operations can be performed sequentially or in parallel. Data and instructions can be stored in a single memory device or across multiple memory devices.

Aspects of the disclosure have been described in terms of illustrative embodiments thereof. Numerous other embodiments, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of,” “any combination of,” or “and/or” example elements listed therein. Also, terms such as “based on” should be understood as “based at least in part on”.

Those of ordinary skill in the art, using the disclosures provided herein, will understand that the elements of any of the claims discussed herein can be adapted, rearranged, expanded, omitted, combined, or modified in various ways without deviating from the scope of the present disclosure. Some implementations are described with a reference numeral for example illustrated purposes and is not meant to be limiting.

What is claimed is:

1. A computer-implemented method, comprising:
generating a recommendation for a comestible menu item based on at least one of: (i) streaming content data or (ii) user interface data;
obtaining data indicative of user selection of the comestible menu item;
accessing current streaming content data;
generating a data structure comprising: (i) the selected comestible menu item and (ii) the current streaming content data;
transmitting, via an application programming interface (API) associated with a delivery service, the generated data structure to a delivery service;
accessing, via the API associated with the delivery service, order update data;
processing the order update data and current streaming content data to determine: (i) a location within the user interface for an embedding window, and (ii) the order update content to provide within the embedding window;
generating the embedding window; and
updating the user interface to provide the order update content for display within the embedding window.

2. The computer-implemented method of claim 1, comprising:
processing the order update data and the current streaming content data to determine a time to display the order update data within the embedding window based on: (i) the order update data and (ii) characteristic data associated with at least one comestible menu item.

3. The computer-implemented method of claim 2, wherein the characteristic data is indicative of the comestible menu item being at least one of (i) a refrigerated item, (ii) a frozen item, or (iii) a warm item, comprising:
based on the characteristic data being indicative of the comestible menu item being at least one of (i) a refrigerated item, (ii) a frozen item, or (iii) a warm item, updating the user interface to provide the order update content in near-real time.

4. The computer-implemented method of claim 2, wherein the characteristic data is indicative of an item being shelf stable, comprising:
based on the characteristic data being indicative of the item being shelf stable, delaying updating the user interface to provide the order update content.

5. The computer-implemented method of claim 1, comprising processing the order update data and the current streaming content data to determine a time to display a notification within the embedding window by:
determining a time window for displaying the notification based on the order update data;
processing plot data associated with the current streaming content data to determine a portion of the time window to display the notification; and
generating the embedding window to render during the portion of the time window.

6. The computer-implemented method of claim 1, wherein processing the order update data and the current streaming content data to determine the location within the user interface for an embedding window comprises:
determining a first time window for displaying a notification based on a progress associated with the order update;
processing a plurality of image frames by, for each image frame of the plurality of image frames:
identifying a primary subject of the image frame;
identifying a portion of the image frame that does not contain a primary subject; and
based on identifying that the portion of the image frame does not contain the primary subject, selecting the portion as a candidate location within the user interface for the embedding window; and
selecting the location for the embedding window based on determining that a plurality of candidate locations overlap.

7. The computer-implemented method of claim 1, wherein the user interface data comprises at least one of content selection data or content search data.

8. The computer-implemented method of claim 1, wherein the streaming content data comprises metadata comprising at least one of: (i) a title, (ii) frame data, (iii) category data, or (iv) a type of content.

9. The computer-implemented method of claim 8, wherein the type of content comprises at least one of: (i) a movie, (ii) an episode, or (iii) a live program.

10. A computing system comprising:
one or more processors; and
one or more non-transitory computer readable media storing instructions that are executable by the one or more processors to perform operations, the operations comprising computer-implemented method, comprising:
obtaining, by a delivery service computing system, service order request data comprising: (i) an item and (ii) streaming content data;
accessing data indicative of a courier location approaching a delivery location associated with the service order request;
based on accessing the data indicative of the courier location approaching the delivery location, generating order update data;
accessing network traffic data;
based on the streaming content data and network traffic data, determining a time to transmit the order update data; and
transmitting, via an application programming interface, data comprising the order update to be provided for display via a display device.

11. The computing system of claim 10, wherein the display device comprises at least one of: (i) a client device or (ii) a television.

12. The computing system of claim 10, wherein the service order request data is obtained via a client device and wherein the client device is a different device from the display device.

13. The computing system of claim 10, wherein the order update data comprises at least one of (i) merchant data or (ii) courier data.

14. The computing system of claim 10, wherein the service order request data is obtained via the display device.

15. One or more non-transitory computer readable media storing instructions that are executable by one or more processors to perform operations, the operations comprising:
obtaining, via a sensor of a client device, user input data indicative of initiation of a streaming session on a second device;
obtaining, via the sensor of the client device, user input data indicative of selection of a comestible menu item associated with a delivery service application;
obtaining, via an application programming interface in communication with a delivery service computing system, order update data;
accessing streaming data associated with the streaming session on the second device; and
based on the order update data and the streaming data, generating a data structure comprising instructions, that are executable to cause the second computing device to adjust streaming content associated with the streaming session based on the order update data.

16. The one or more non-transitory computer readable media of claim 15, wherein adjusting the streaming content based on the order update data comprises at least one of: (i) generating an embedding window within the streaming content for providing the order update data for display or (ii) pausing the streaming content.

17. The one or more non-transitory computer readable media of claim 15, wherein the streaming session and delivery session are associated with an account identifier.

18. The one or more non-transitory computer readable media of claim 15, the operations comprising:
accessing network bandwidth usage data;
determining a predicted decrease in network bandwidth usage at a future time; and
based on a predicted decrease in network bandwidth usage at the future time, delaying transmission of the executable instructions until the time associated with the decrease in network bandwidth usage.

19. The one or more non-transitory computer readable media of claim 15, the operations comprising:
providing an order update via a user interface of the client device.

20. The one or more non-transitory computer readable media of claim 15, comprising:
generating a recommended comestible menu item based on the streaming data; and
providing for display, via the client device, the recommended comestible menu item.
